(19) United States
(12) Patent Application Publication
(10) Pub. No.: US 2026/0239464 A1
(43) Pub. Date: Aug. 13, 2026

(54) METHOD OF COMMUNICATION APPARATUS, AND METHOD OF USER EQUIPMENT (UE)

(71) Applicant: NEC Corporation, Tokyo (JP)

(72) Inventors: Prabhu KALIYAMMAL THIRUVASAGAM, San diego, CA (US); Toshiyuki TAMURA, Ibaraki (JP); Iskren IANEV, Reading (GB); Kundan TIWARI, Bengaluru (IN); Makoto NOBE, Tokyo (JP); Hiroshi DEMPO, Tokyo (JP)

(73) Assignee: NEC Corporation, Tokyo (JP)

(21) Appl. No.: 19/151,002

(22) PCT Filed: Feb. 1, 2024
(86) PCT No.: PCT/JP2024/003199

§ 371 Date: Jul. 25, 2025

(30) Foreign Application Priority Data
Feb. 1, 2023 (IN) 202311006516

(51) Int. Cl. H04W 76/15

(52) U.S. Cl. CPC H04W 76/15

(57) ABSTRACT

An aspect of this disclosure includes a method performed by a first communication apparatus. The method includes: receiving a first message from a second communication apparatus for Network Slice Admission Control (NSAC) for a maximum number of User Equipments (UEs) with at least one Protocol Data Unit (PDU) session/Packet Data Network (PDN) connection based on a UE establishing a PDU session/PDN connection associated with a network slice in the second communication apparatus; and performing NSAC for the maximum number of UEs with at least one PDU session/PDN connection in case of EPC interworking.

### TECHNICAL FIELD

The present disclosure relates to a method of a communication apparatus, a method of a User Equipment (UE), a communication apparatus and a UE.

### BACKGROUND ART

GSMA sent a Liaison Statement (LS) S2-2202800 (NPL 9) to request SA2 to specify the support of the new Network Slice Type (NEST) attribute “maximum number of UEs with at least one PDU session/PDN connection” that was defined in GSMA document Generic Network Slice Template (NPL 10).

The 3rd Generation Partnership Project (3GPP) Service and System Aspects Working Group 2 (SA2) is working to enhance the 5GS architectural capabilities and features. The 3GPP contribution SP-220988 (NPL 11) is an agreed SA2 Technical Enhancement or Improvement (TEI) Work Item Description (WID) for Release 18 and the objective is to specify the request from GSMA to support 5GS enhancement for adding the new NEST attribute “maximum number of UEs with at least one PDU session/PDN connection”.

### CITATION LIST

### Non Patent Literature

NPL 1: 3GPP TR 21.905: “Vocabulary for 3GPP Specifications”. V17.1.0 (2021-12)
NPL 2: 3GPP TS 23.501: “System architecture for the 5G System (5GS)”. V17.6.0 (2022-09)
NPL 3: 3GPP TS 23.502: “Procedures for the 5G System (5GS)”. V17.6.0 (2022-09)
NPL 4: 3GPP TS 23.503: “Policy and charging control framework for the 5G System (5GS); Stage 2”. V17.6.0 (2022-09)
NPL 5: 3GPP TS 23.288: “Architecture enhancements for 5G System (5GS) to support network data analytics services”. V17.6.0 (2022-09)
NPL 6: 3GPP TS 24.501: “Non-Access-Stratum (NAS) protocol for 5G System (5GS); Stage 3”. V18.0.1 (2022-09)
NPL 7: 3GPP TS 33.501: “Security architecture and procedures for 5G system”. V17.7.0 (2022-09)
NPL 8: 3GPP TS 38.413: “NG-RAN; NG Application Protocol (NGAP)”. V17.2.0 (2022-09)
NPL 9: S2-2202800: https://www.3gpp.org/ftp/tsg_sa/WG2_Arch/TSGS2_150E_Electronic_2022-04/Docs/S2-2202800.zip
NPL 10: GSMA NG.116: “Generic Network Slice Template”. V7.0 (2022-06)
NPL 11: SP-220988: https://www.3gpp.org/ftp/tsg_sa/TSG_SA/TSGS_97E_Electronic_2022-09/Docs/SP-220988.zip

### SUMMARY OF INVENTION

### Technical Problem

The current 3GPP specifications (e.g., TS 23.501 (NPL 2) and TS 23.502 (NPL 3)) do not support the GSMA (NPL 10) defined new NEST attribute “maximum number of UEs with at least one PDU session/PDN connection”. For 5GS Network Slice(s) where EPS interworking is supported, this can result in a non-uniform counting restriction as 5GS counts UEs which are registered to 5GS and EPS counts UEs which have at least one PDN connection. There is, therefore, a requirement is required to support uniform counting restriction by considering the new attribute “maximum number of UEs with at least one PDU session/PDN connection”. For example, there is, therefore, a requirement to support uniform counting restriction by considering a new attribute “maximum number of UEs with at least one PDU session/PDN connection” for 5GS Network Slice(s) which can be used by the maximum number of UEs (both 5GS and EPS UEs) simultaneously. However, there is no mechanism to support at least one of the new attributes and the requirement in the current 3GPP specifications.

### Solution to Problem

In a first example aspect, a method of a communication apparatus includes:
receiving a first message including Single Network Slice Selection Assistance Information (S-NSSAI);
determining whether the S-NSSAI has an attribute related to a maximum number of User Equipments (UEs) that use a network slice simultaneously with at least one of a Protocol Data Unit (PDU) session and a Packet Data Network (PDN) connection; and
retaining sending a second message in a case of determining that the S-NSSAI has the attribute,
wherein the second message includes the S-NSSAI for performing a number of UEs per network slice availability check and update procedure.

In a second example aspect, a method of a communication apparatus includes:
receiving a first message including Single Network Slice Selection Assistance Information (S-NSSAI);
determining whether the S-NSSAI has an attribute related to a maximum number of User Equipments (UEs) that use a network slice simultaneously with at least one of a Protocol Data Unit (PDU) session and a Packet Data Network (PDN) connection; and
sending a second message in a case of determining that the S-NSSAI has the attribute,
wherein the second message includes the S-NSSAI for performing a number of UEs per network slice availability check and update procedure.

In a third example aspect, a method of a User Equipment (UE) includes:
sending a first message including Single Network Slice Selection Assistance Information (S-NSSAI); and
receiving a second message including a list which includes at least one S-NSSAI that a number of UEs per network slice availability check and update procedure is not performed in a case where the S-NSSAI has an attribute related to a maximum number of UEs that use a network slice simultaneously with at least one of a Protocol Data Unit (PDU) session and a Packet Data Network (PDN) connection, and
wherein the S-NSSAI is included in the list.

In a fourth example aspect, a method of a communication apparatus includes:
receiving a first message including Single Network Slice Selection Assistance Information (S-NSSAI) from an Access and Mobility Management Function (AMF);
determining whether the S-NSSAI has an attribute related to a maximum number of User Equipments (UEs) that use a network slice simultaneously with at least one of a Protocol Data Unit (PDU) session and a Packet Data Network (PDN) connection; and
retaining performing a number of UEs per network slice availability check and update procedure for the S-NSSAI in a case of determining that the S-NSSAI has the attribute.

In a fifth example aspect, a method of a communication apparatus includes:
communicating with another communication apparatus; and
sending, to the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

In a sixth example aspect, a method of a communication apparatus includes:
communicating with another communication apparatus; and
receiving, from the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

In a seventh example aspect, a communication apparatus includes:
means for receiving a first message including Single Network Slice Selection Assistance Information (S-NSSAI);
means for determining whether the S-NSSAI has an attribute related to a maximum number of User Equipments (UEs) that use a network slice simultaneously with at least one of a Protocol Data Unit (PDU) session and a Packet Data Network (PDN) connection; and
means for retaining sending a second message in a case of determining that the S-NSSAI has the attribute,
wherein the second message includes the S-NSSAI for performing a number of UEs per network slice availability check and update procedure.

In an eighth example aspect, a communication apparatus includes:
means for receiving a first message including Single Network Slice Selection Assistance Information (S-NSSAI);
means for determining whether the S-NSSAI has an attribute related to a maximum number of User Equipments (UEs) that use a network slice simultaneously with at least one of a Protocol Data Unit (PDU) session and a Packet Data Network (PDN) connection; and
means for sending a second message in a case of determining that the S-NSSAI has the attribute,
wherein the second message includes the S-NSSAI for performing a number of UEs per network slice availability check and update procedure.

In a ninth example aspect, a User Equipment (UE) includes:
means for sending a first message including Single Network Slice Selection Assistance Information (S-NSSAI); and
means for receiving a second message including a list which includes at least one S-NSSAI that a number of UEs per network slice availability check and update procedure is not performed in a case where the S-NSSAI has an attribute related to a maximum number of UEs that use a network slice simultaneously with at least one of a Protocol Data Unit (PDU) session and a Packet Data Network (PDN) connection, and
wherein the S-NSSAI is included in the list.

In a tenth example aspect, a communication apparatus includes:
means for receiving a first message including Single Network Slice Selection Assistance Information (S-NSSAI) from an Access and Mobility Management Function (AMF);
means for determining whether the S-NSSAI has an attribute related to a maximum number of User Equipments (UEs) that use a network slice simultaneously with at least one of a Protocol Data Unit (PDU) session and a Packet Data Network (PDN) connection; and
means for retaining performing a number of UEs per network slice availability check and update procedure for the S-NSSAI in a case of determining that the S-NSSAI has the attribute.

In an eleventh example aspect, a communication apparatus includes:
means for communicating with another communication apparatus; and
means for sending, to the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

In a twelfth example aspect, a communication apparatus includes:
means for communicating with another communication apparatus; and
means for receiving, from the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

### Advantageous Effects of Invention

According to the present disclosure, it is possible to provide a method or the like for supporting at least one of the new attributes and the requirement in the current 3GPP specifications.

### BRIEF DESCRIPTION OF DRAWINGS

FIG. 1 is a signaling diagram of a First example of a First Aspect.

FIG. 2 is a signaling diagram of a Second example of the First Aspect.

FIG. 3 is a signaling diagram of a First example of a Second Aspect.

FIG. 4 is a signaling diagram of a Second example of the Second Aspect.

FIG. 5 is a signaling diagram of a First example of a Third Aspect.

FIG. 6 is a signaling diagram of a Second example of the Third Aspect.

FIG. 7 is a signaling diagram of a First example of a Fourth Aspect.

FIG. 8 is a diagram illustrating a system overview.

FIG. 9 is a block diagram illustrating a UE.

FIG. 10 is a block diagram illustrating an (R)AN node.

FIG. 11 is a diagram illustrating System overview of (R)AN node based on O-RAN architecture.

FIG. 12 is a block diagram illustrating an RU.

FIG. 13 is a block diagram illustrating a DU.

FIG. 14 is a block diagram illustrating a CU.

FIG. 15 is a block diagram illustrating an AMF.

FIG. 16 is a block diagram illustrating an SMF.

FIG. 17 is a block diagram illustrating an UPF.

FIG. 18 is a block diagram illustrating a PCF.

FIG. 19 is a block diagram illustrating an NEF.

FIG. 20 is a block diagram illustrating a UDM.

FIG. 21 is a block diagram illustrating an NSSF.

FIG. 22 is a block diagram illustrating an NSACF.

### DESCRIPTION OF EMBODIMENTS

### Abbreviations

For the purposes of the present document, the abbreviations given in TR 21.905 (NPL 1) and the following apply. An abbreviation defined in the present document takes precedence over the definition of the same abbreviation, if any, in TR 21.905 (NPL 1).

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QoS Identifier |
| ABBA | Anti-Bidding-down Between Architectures |
| AF | Application Function |
| AMF | Access and Mobility Management Function |
| API | Application Programming Interface |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BBF | Broadband Forum |
| BMCA | Best Master Clock Algorithm |
| BSF | Binding Support Function |
| CAG | Closed Access Group |
| CAPIF | Common API Framework for 3GPP northbound APIs |
| CHF | Charging Function |
| CN PDB | Core Network Packet Delay Budget |
| CP | Control Plane |
| CU | Centralized Unit |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| DU | Distributed Unit |
| ePDG | evolved Packet Data Gateway |
| EAP | Extensible Authentication Protocol |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| GPSI | Generic Public Subscription Identifier |
| GUAMI | Globally Unique AMF Identifier |
| GUTI | Globally Unique Temporary UE Identity |
| HR | Home Routed (roaming) |
| IAB | Integrated access and backhaul |
| IMEI | International Mobile Equipment Identity |
| IMEI/TAC | IMEI Type Allocation Code |
| IMS | IP Multimedia Subsystem |
| IOWN | Innovative Optical and Wireless Network |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| LTE | Long Term Evolution |
| MAC | Medium Access Control |
| MCC | Mobile country code |
| MCX | Mission Critical Service |
| MDBV | Maximum Data Burst Volume |
| MFBR | Maximum Flow Bit Rate |
| MICO | Mobile Initiated Connection Only |
| MNC | Mobile Network Code |
| MO | Mobile Originated |
| MPS | Multimedia Priority Service |
| MPTCP | Multi-Path TCP Protocol |
| MT | Mobile Terminated |
| MT | Mobile Termination |
| N3IWF | Non-3GPP InterWorking Function |
| N5CW | Non-5G-Capable over WLAN |
| NAI | Network Access Identifier |
| NAS | Non-Access Stratum |
| NEF | Network Exposure Function |
| NEST | Network Slice Type |
| NF | Network Function |
| NGAP | Next Generation Application Protocol |
| ngKSI | Next Generation Key Set Identifier |
| NID | Network identifier |
| NPN | Non-Public Network |
| NR | New Radio |
| NRF | Network Repository Function |
| NSAC | Network Slice Admission Control |
| NSACF | Network Slice Admission Control Function |
| NSI ID | Network Slice Instance Identifier |
| NSSAA | Network Slice-Specific Authentication and |
| | Authorization |
| NSSAAF | Network Slice-Specific Authentication and |
| | Authorization Function |
| NSSAI | Network Slice Selection Assistance Information |
| NSSF | Network Slice Selection Function |
| NSSP | Network Slice Selection Policy |
| NW-TT | Network-side TSN translator |
| NWDAF | Network Data Analytics Function |
| O-RAN | Open RAN Alliance |
| O-DU | O-RAN Distributed Unit |
| O-CU | O-RAN Centralized Unit |
| O-RU | O-RAN Radio Unit |
| PCF | Policy Control Function |
| PDB | Packet Delay Budget |
| PDCP | Packet Data Convergence Protocol |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| QoS | Quality of Service |
| RACS | Radio Capabilities Signalling optimisation |
| (R)AN | (Radio) Access Network |
| RG | Residential Gateway |
| RU | Radio Unit |
| RIM | Remote Interference Management |
| RLC | Radio Link Control |
| RQA | Reflective QoS Attribute |
| RQI | Reflective QoS Indication |
| RRC | Radio Resource Control |
| RSN | Redundancy Sequence Number |
| SA NR | Standalone New Radio |
| SBA | Service Based Architecture |
| SBI | Service Based Interface |
| SCP | Service Communication Proxy |
| SD | Slice Differentiator |
| SDAP | Service Data Adaptation Protocol |
| SEAF | Security Anchor Functionality |
| SEPP | Security Edge Protection Proxy |
| SMF | Session Management Function |
| SMS | Short Message Service |
| SMSF | Short Message Service Function |
| SN | Sequence Number |
| SN name | Serving Network Name. |
| SNPN | Stand-alone Non-Public Network |
| S-NSSAI | Single Network Slice Selection Assistance Information |
| SOR | Steering Of Roaming |
| SSC | Session and Service Continuity |
| SSCMSP | Session and Service Continuity Mode Selection Policy |
| SST | Slice/Service Type |
| SUCI | Subscription Concealed Identifier |
| SUPI | Subscription Permanent Identifier |
| SV | Software Version |
| TAI | Tracking Area Identity |
| TCP | Transmission Control Protocol |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMF | UE radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UP | User Plane |
| UPF | User Plane Function |
| URLLC | Ultra Reliable Low Latency Communication |
| URRP-AMF | UE Reachability Request Parameter for AMF |
| URSP | UE Route Selection Policy |
| UU | Interface between User Equipment and Radio Access |
| | Network |
| VID | VLAN Identifier |
| VLAN | Virtual Local Area Network |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |
| WLAN | Wireless Local Area Network |
| WUS | Wake Up Signal |

### Definitions

For the purposes of the present document, the terms and definitions given in 3GPP TR 21.905 (NPL 1), and the following apply. A term defined in the present document takes precedence over the definition of the same term, if any, in 3GPP TR 21.905 (NPL 1).

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

In this disclosure, expression “A and/or B” may mean “at least one of A and B”.

Signaling(s) or message(s) between communication apparatuses (e.g., UE(s), AMF(s), SMF(s), NSACF(s) etc.) may be realized by using existing message(s) or newly defined message(s) between the communication apparatuses.

An example object of this disclosure is to provide a method and apparatus that can solve the above problem.

A method of a communication apparatus according to example aspect of this disclosure includes receiving a first message including Single Network Slice Selection Assistance Information (S-NSSAI). The method includes determining whether the S-NSSAI has an attribute related to a maximum number of User Equipments (UEs) that use a network slice simultaneously with at least one of a Protocol Data Unit (PDU) session and a Packet Data Network (PDN) connection. The method includes retaining sending a second message in a case of determining that the S-NSSAI has the attribute. The second message includes the S-NSSAI for performing a number of UEs per network slice availability check and update procedure.

A method of a communication apparatus according to example aspect of this disclosure includes receiving a first message including Single Network Slice Selection Assistance Information (S-NSSAI). The method includes determining whether the S-NSSAI has an attribute related to a maximum number of User Equipments (UEs) that use a network slice simultaneously with at least one of a Protocol Data Unit (PDU) session and a Packet Data Network (PDN) connection. The method includes sending a second message in a case of determining that the S-NSSAI has the attribute. The second message includes the S-NSSAI for performing a number of UEs per network slice availability check and update procedure.

A method of a User Equipment (UE) according to example aspect of this disclosure includes sending a first message including Single Network Slice Selection Assistance Information (S-NSSAI). The method includes receiving a second message including a list which includes at least one S-NSSAI that a number of UEs per network slice availability check and update procedure is not performed in a case where the S-NSSAI has an attribute related to a maximum number of UEs that use a network slice simultaneously with at least one of a Protocol Data Unit (PDU) session and a Packet Data Network (PDN) connection. The S-NSSAI is included in the list.

A method of a communication apparatus according to example aspect of this disclosure includes receiving a first message including Single Network Slice Selection Assistance Information (S-NSSAI) from an Access and Mobility Management Function (AMF). The method includes determining whether the S-NSSAI has an attribute related to a maximum number of User Equipments (UEs) that use a network slice simultaneously with at least one of a Protocol Data Unit (PDU) session and a Packet Data Network (PDN) connection. The method includes retaining performing a number of UEs per network slice availability check and update procedure for the S-NSSAI in a case of determining that the S-NSSAI has the attribute.

A method of a communication apparatus according to example aspect of this disclosure includes communicating with another communication apparatus. The method includes sending, to the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

A method of a communication apparatus according to example aspect of this disclosure includes communicating with another communication apparatus. The method includes receiving, from the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

A communication apparatus according to example aspect of this disclosure includes a memory, and at least one hardware processor coupled to the memory. The at least one hardware processor is configured to receive a first message including Single Network Slice Selection Assistance Information (S-NSSAI). The at least one hardware processor is configured to determine whether the S-NSSAI has an attribute related to a maximum number of User Equipments (UEs) that use a network slice simultaneously with at least one of a Protocol Data Unit (PDU) session and a Packet Data Network (PDN) connection. The at least one hardware processor is configured to retain sending a second message in a case of determining that the S-NSSAI has the attribute. The second message includes the S-NSSAI for performing a number of UEs per network slice availability check and update procedure.

A communication apparatus according to example aspect of this disclosure includes a memory, and at least one hardware processor coupled to the memory. The at least one hardware processor is configured to receive a first message including Single Network Slice Selection Assistance Information (S-NSSAI). The at least one hardware processor is configured to determine whether the S-NSSAI has an attribute related to a maximum number of User Equipments (UEs) that use a network slice simultaneously with at least one of a Protocol Data Unit (PDU) session and a Packet Data Network (PDN) connection. The at least one hardware processor is configured to send a second message in a case of determining that the S-NSSAI has the attribute. The second message includes the S-NSSAI for performing a number of UEs per network slice availability check and update procedure.

A User Equipment (UE) according to example aspect of this disclosure includes a memory, and at least one hardware processor coupled to the memory. The at least one hardware processor is configured to send a first message including Single Network Slice Selection Assistance Information (S-NSSAI). The at least one hardware processor is configured to receive a second message including a list which includes at least one S-NSSAI that a number of UEs per network slice availability check and update procedure is not performed in a case where the S-NSSAI has an attribute related to a maximum number of UEs that use a network slice simultaneously with at least one of a Protocol Data Unit (PDU) session and a Packet Data Network (PDN) connection. The S-NSSAI is included in the list.

A communication apparatus according to example aspect of this disclosure includes a memory, and at least one hardware processor coupled to the memory. The at least one hardware processor is configured to receive a first message including Single Network Slice Selection Assistance Information (S-NSSAI) from an Access and Mobility Management Function (AMF). The at least one hardware processor is configured to determine whether the S-NSSAI has an attribute related to a maximum number of User Equipments (UEs) that use a network slice simultaneously with at least one of a Protocol Data Unit (PDU) session and a Packet Data Network (PDN) connection. The at least one hardware processor is configured to retain performing a number of UEs per network slice availability check and update procedure for the S-NSSAI in a case of determining that the S-NSSAI has the attribute.

A communication apparatus according to example aspect of this disclosure includes a memory, and at least one hardware processor coupled to the memory. The at least one hardware processor is configured to communicate with another communication apparatus. The at least one hardware processor is configured to send, to the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

A communication apparatus according to example aspect of this disclosure includes a memory, and at least one hardware processor coupled to the memory. The at least one hardware processor is configured to communicate with another communication apparatus. The at least one hardware processor is configured to receive, from the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

### First Aspect

This aspect comprises a mechanism to support the GSMA defined new attribute “maximum number of UEs with at least one PDU session/PDN connection” per Network Slice by configuring the AMF and the SMF with the attribute details for monitoring and limiting the UEs count with NSACF in a uniform manner.

For example, this aspect comprises a mechanism to support the GSMA defined new attribute “maximum number of UEs with at least one PDU session/PDN connection” per Network Slice which can be used by UEs (both 5GS and EPS UEs) simultaneously by configuring the AMF and the SMF with the attribute details for monitoring and limiting the UEs count with NSACF in a uniform manner.

Network slicing enables construction of multiple tailor-made dedicated logical networks based on the requirements of customers on a shared infrastructure. A Network Slice is identified by a Single Network Slice Selection Assistance Information (S-NSSAI). S-NSSAI includes a Slice Service Type (SST) and, optionally, a Slice Differentiator (SD) to differentiate the same SSTs customized for different groups/purposes. A PDU session belongs to one and only a specific Network Slice instance per PLMN.

The GSMA NG. 116 (NPL10) provides a Generic Network Slice Template (GST) which is a set of attributes that can characterize a type of Network Slice. NEST is a GST filled with values which are assigned to express the requirements of a customer application or use case. A UE can use a Network Slice (S-NSSAI) that meets the customer requirements expressed in terms of attributes and parameter values.

Network Slice Admission Control (NSAC) controls the number of registered UEs per Network Slice and the number of PDU sessions per Network Slice. A Network Slice Admission Control Function (NSACF) enforces NSAC to the S-NSSAIs which are subject to NSAC by coordinating with the AMF and the SMF.

It is assumed that 5GS will support EPS interworking for a set of Network Slice(s). In this scenario, the attribute “maximum number of UEs with at least one PDU session/PDN connection” is supported for 5GS Network Slice(s) which can be used by UEs (both 5GS and EPS UEs) simultaneously to apply count restrictions in a uniform manner in both 5GS and EPS.

The attribute “maximum number of UEs with at least one PDU session/PDN connection” may describe (or mean or indicate or be related to) the maximum number of UEs that can use the network slice simultaneously with at least one PDU session/PDN connection (or with at least one of a PDU session and a PDN connection).

### First Example of the First Aspect

This example comprises a mechanism for configuring the AMF to be aware of Network Slice(s) with its attribute details, including the GSMA defined new attribute “maximum number of UEs with at least one PDU session/PDN connection” and the existing attribute “UEs registered to 5GS”, and performing the number of UEs per S-NSSAI availability check and update procedure for Network Slice(s) which match one of the attributes and subject to NSAC during the Registration procedure.

The attribute “UEs registered to 5GS” may be expressed as “Maximum number of UEs” or an old attribute in this disclosure. “This disclosure” may mean at least one Aspect.

In this disclosure, in the number of UEs per S-NSSAI availability check and update procedure, checking the count of the number of registered UEs may be performed.

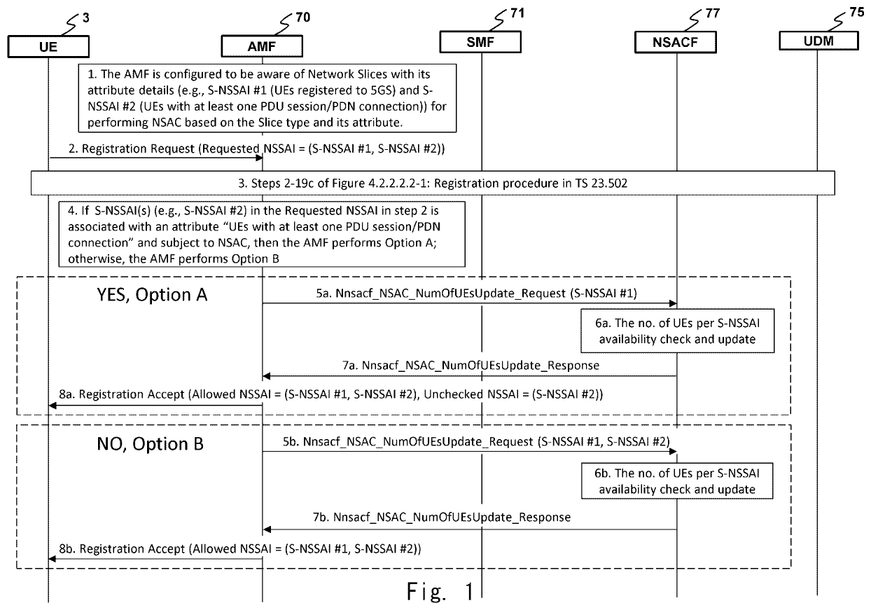

The detailed processes of the First example of the First Aspect are described below with reference to FIG. 1. FIG. 1 shows a procedure for configuring the AMF to be aware of Network Slice(s) (S-NSSAI(s)) with different attributes and applying NSAC during a registration procedure.

Step 1: The AMF 70 is configured to be aware of Network Slice(s) (S-NSSAI(s)) with its attributes, such as UEs 3 registered to 5GS and UEs 3 with at least one PDU session or PDN connection, for performing NSAC based on the Slice type and its attribute. For example, S-NSSAI #1 (UEs registered to 5GS) and S-NSSAI #2 (UEs with at least one PDU session/PDN connection) are two Network Slices with specific attributes and they are subject to NSAC.

In this disclosure, for example, S-NSSAI #1 may have or may be associated with the attribute “UEs registered to 5GS”.

In this disclosure, for example, S-NSSAI #2 may have or may be associated with the attribute “maximum number of UEs with at least one PDU session/PDN connection”.

In this disclosure, for example, the AMF 70 may be configured to be aware of (or may be configured to determine) attribute(s) for network slice(s) (or the S-NSSAI(s)).

In this disclosure, for example, the AMF 70 may be configured to be aware that S-NSSAI #1 has or is associated with the attribute “UEs registered to 5GS”. And the AMF 70 may be configured to be aware that S-NSSAI #2 has or is associated with the attribute “maximum number of UEs with at least one PDU session/PDN connection”.

In this disclosure, for example, the AMF 70 may be aware or understand that S-NSSAI #1 has or is associated with the attribute “UEs registered to 5GS”, and S-NSSAI #2 has or is associated with the attribute “maximum number of UEs with at least one PDU session/PDN connection”.

In this disclosure, for example, the AMF 70 may be configured by information related to the attributes (e.g., “UEs registered to 5GS” and “maximum number of UEs with at least one PDU session/PDN connection”) per network slice (or S-NSSAI). In this disclosure, the information related to the attributes may indicate that S-NSSAI #1 has or is associated with the attribute “UEs registered to 5GS”, and/or the information related to the attributes may indicate that S-NSSAI #2 has or is associated with the attribute “maximum number of UEs with at least one PDU session/PDN connection”.

In this disclosure, for example, based on the information related to the attributes, the AMF 70 may determine which network slice (or S-NSSAI) has or is associated which attributes.

In this disclosure, for example, the AMF 70 may store the information related to the attributes in advance or may receive the information related to the attributes from other network node(s).

In this disclosure, for example, the attribute “UEs registered to 5GS” may indicate that the counting or updating the number of UEs (or NSAC related to the number of UEs) is performed in a case where the registration procedure for the S-NSSAI is performed.

In this disclosure, for example, the attribute “maximum number of UEs with at least one PDU session/PDN connection” may indicate that the counting or updating the number of UEs (or NSAC related to the number of UEs) is performed in a case where the PDU session establishment procedure for the S-NSSAI is performed.

In this disclosure, for example, the attribute “maximum number of UEs with at least one PDU session/PDN connection” may indicate that the counting or updating the number of UEs (or NSAC related to the number of UEs) is not performed in a case where the registration procedure for the S-NSSAI is performed, but performed in a case where the PDU session establishment procedure for the S-NSSAI is performed.

In this disclosure, for example, the attribute “maximum number of UEs with at least one PDU session/PDN connection” may be expressed as “maximum number of UEs with at least one PDU session in 5GS, and at least one PDN connection in EPS” or “maximum number of UEs with at least one PDU session and PDN connection” or “maximum number of UEs with at least one PDU session or PDN connection” or “UEs with at least one PDU session/PDN connection” or “UEs with at least one PDU session”.

For the case of Network Slice(s) with the attribute “maximum number of UEs with at least one PDU session/PDN connection”, a UE 3 registered in a 5GS Network Slice with no PDU session established is not counted. Also, the attribute “maximum number of UEs with at least one PDU session/PDN connection” is not used together with the attribute “maximum number of UEs”.

Step 2: NSSAI is a collection of S-NSSAI(s). Requested NSSAI is NSSAI provided by the UE 3 to the Serving PLMN during a registration procedure. Here, the UE 3 provides Requested NSSAI to the AMF 70 as part of the Registration Request and the Requested NSSAI includes two S-NSSAIs (S-NSSAI #1 and S-NSSAI #2).

For example, the UE 3 may send the Registration Request message including the Requested NSSAI which includes S-NSSAI #1 and S-NSSAI #2.

Optionally, if the Serving PLMN is not a UE's 3 Home PLMN, then the UE 3 may include a Mapping of Requested NSSAI which is the mapping of each S-NSSAI of the Requested NSSAI to the HPLMN S-NSSAIS.

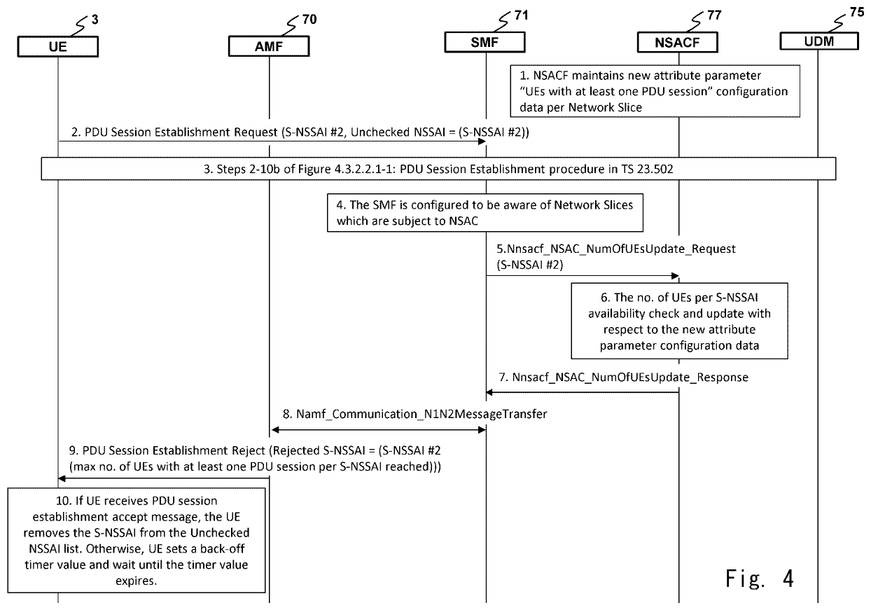

Step 3: Step 2 to step 19c of the FIG. 4.2.2.2.2-1: Registration procedure in TS 23.502 (NPL3) take place.

Step 4: The AMF 70 is configured with the information that indicates which Network Slice is subject to NSAC.

For example, the AMF 70 may determine (or may confirm, or may check) whether S-NSSAI(s) (e.g., S-NSSAI #2) in the Requested NSSAI in step 2 is associated with the attribute “maximum number of UEs with at least one PDU session/PDN connection”.

In addition, the AMF 70 may determine (or may confirm, or may check) whether S-NSSAI(s) (e.g., S-NSSAI #2) in the Requested NSSAI in step 2 is subject to NSAC.

If S-NSSAI(s) (e.g., S-NSSAI #2) in the Requested NSSAI in step 2 is associated with the attribute “maximum number of UEs with at least one PDU session/PDN connection” and/or subject to NSAC (e.g., in a case where the AMF 70 determines that S-NSSAI(s) (e.g., S-NSSAI #2) in the Requested NSSAI in step 2 is associated with the attribute “maximum number of UEs with at least one PDU session/PDN connection” and subject to NSAC), then the AMF 70 performs Option A in FIG. 1. Otherwise, if S-NSSAI(s) (e.g., S-NSSAI #1) in the Requested NSSAI in step 2 is associated with the attribute “UEs registered to 5GS” and subject to NSAC, then the AMF 70 performs Option B in FIG. 1. The S-NSSAI #1 and S-NSSAI #2 may be subject to NSAC in this disclosure.

For example, in a case where S-NSSAI #1 is associated with the attribute “UEs registered to 5GS” and S-NSSAI #2 is associated with the attribute “maximum number of UEs with at least one PDU session/PDN connection” and/or S-NSSAI #1 and S-NSSAI #2 are subject to NSAC, the AMF 70 may perform Option A in FIG. 1.

For example, in a case where S-NSSAI #1 and S-NSSAI #2 are associated with the attribute “UEs registered to 5GS” and/or S-NSSAI #1 and S-NSSAI #2 are subject to NSAC, the AMF 70 may perform Option B in FIG. 1.

The AMF 70 triggers checking of the number of UEs per network slice availability. The AMF 70 triggers an update procedure to update the number of UEs registered for an S-NSSAI with the attribute “UEs registered to 5GS” and subject to NSAC. For example, the AMF 70 may trigger the number of UEs per network slice availability check and update procedure to update the number of UEs registered for S-NSSAI with the attribute “UEs registered to 5GS” and subject to NSAC. The number of UEs per network slice availability check and update procedure may be expressed as the number of UEs per S-NSSAI availability check and update procedure in this disclosure.

There may be multiple NSACFs 77 for different S-NSSAIs which are subject to NSAC and thus the AMF 70 triggers checking of the number of UEs 3 per network slice availability and sending of the update request to multiple NSACFs 77.

### Option A

Step 5a: A Network Slice (e.g., S-NSSAI #2) which is associated with the attribute “maximum number of UEs with at least one PDU session/PDN connection”, but for which a PDU session is not yet established is not considered for NSAC during the registration procedure. Hence, only Network Slice(s) (e.g., S-NSSAI #1) which are associated with the attribute “UEs registered to 5GS” and subject to NSAC are considered at this stage.

The AMF 70 uses an Nnsacf_NSAC_NumOfUEsUpdate_Request service operation to share the UE ID, the S-NSSAI(s) value(s), and Access Type information with an NSACF 77 to increase the number of UEs 3 registered with the same S-NSSAI(s).

The S-NSSAI(s) value(s) may be expressed as S-NSSAI(s) in this disclosure.

For example, the AMF 70 may send an Nnsacf_NSAC_NumOfUEsUpdate_Request message including S-NSSAI #1 to the NSACF 77.

For example, the AMF 70 may send the Nnsacf_NSAC_NumOfUEsUpdate_Request message to perform the number of UEs per S-NSSAI availability check and update procedure.

For example, the AMF 70 may not send (or may retain sending) the Nnsacf_NSAC_NumOfUEsUpdate_Request message including S-NSSAI #2 in a case where S-NSSAI #2 has the attribute “maximum number of UEs with at least one PDU session/PDN connection”.

For example, the AMF 70 may not include S-NSSAI #2 in the Nnsacf_NSAC_NumOfUEsUpdate_Request message in a case where S-NSSAI #2 has the attribute “maximum number of UEs with at least one PDU session/PDN connection”.

Step 6a: The NSACF 77 checks the count of the number of registered UEs 3 per Network Slice (i.e., S-NSSAI), increases the count, and allows the UE 3 to use the same S-NSSAI if the count does not exceed a maximum limit.

For example, the NSACF 77 may check the count of the number of registered UEs 3 for S-NSSAI #1, and increase the count and allow the UE 3 to use S-NSSAI #1 in a case where the count does not exceed the maximum limit.

For example, the NSACF 77 may check the count of the number of registered UEs 3 for S-NSSAI #1, and may not increase the count and may not allow the UE 3 to use S-NSSAI #1 in a case where the count exceeds the maximum limit.

Step 7a: The NSACF 77 uses an Nnsacf_NSAC_NumOfUEsUpdate_Response service operation to inform to the AMF 70 of whether the limit of the maximum number of UEs 3 registered per Network Slice has been reached or not. The limit of the maximum number of UEs registered per Network Slice may be expressed as the maximum number of UEs registered per Network Slice in this disclosure.

For example, the NSACF 77 may send an Nnsacf_NSAC_NumOfUEsUpdate_Response message including information indicating that the maximum number of UEs registered for S-NSSAI #1 is not reached in a case where the maximum number of UEs registered for S-NSSAI #1 is not reached. In this disclosure, “the maximum number of UEs is not reached” may be expressed as “the maximum number of UEs has not been reached”.

For example, the NSACF 77 may send the Nnsacf_NSAC_NumOfUEsUpdate_Response message including information indicating that the maximum number of UEs registered for S-NSSAI #1 is reached in a case where the maximum number of UEs registered for S-NSSAI #1 is reached. In this disclosure, “the maximum number of UEs is reached” may be expressed as “the maximum number of UEs has been reached”.

Step 8a: Upon reception of the response from the NSACF 77, the AMF 70 sends a Registration Accept message to the UE 3 including at least one of the Allowed NSSAI and the Rejected NSSAI. The Allowed NSSAI indicates a set of S-NSSAIs which the UE 3 can use to access services from the serving PLMN in the current Registration Area. The Rejected NSSAI indicates a set of S-NSSAIs which the UE 3 cannot use for accessing services. The Registration Accept message also includes the Unchecked NSSAI. The Unchecked NSSAI indicates a set of S-NSSAIs which are subject to NSAC and to be checked with the NSACF 77 during the PDU session establishment procedure. The Unchecked NSSAI may not be included in the Registration Accept message.

The Unchecked NSSAI includes a set of S-NSSAIs with the attribute “maximum number of UEs with at least one PDU session/PDN connection” and its availability is not yet checked with the NSACF 77 during the Registration procedure as the PDU session to the UE 3 is not established. UEs 3 can use S-NSSAI(s) specified in the Unchecked NSSAI as far as that S-NSSAI(s) is in the Allowed NSSAI while requesting PDU session establishment, but the availability of the S-NSSAI(s) will be known only at the end of the PDU session establishment procedure after checking with the NSACF 77. The Unchecked NSSAI may include S-NSSAI(s) that the number of UEs per S-NSSAI availability check and update procedure is not performed. The Unchecked NSSAI may include S-NSSAI(s) that the number of UEs per S-NSSAI availability check and update procedure is not performed during the registration procedure. The Unchecked NSSAI may be a list of S-NSSAI(s) that the number of UEs per S-NSSAI availability check and update procedure is not performed. The Unchecked NSSAI may be a list of S-NSSAI(s) that the number of UEs per S-NSSAI availability check and update procedure is not performed during the registration procedure. The AMF 70 may store the Unchecked NSSAI. When the UE 3 performs a mobility registration procedure upon reselection of a cell of a TAI not belonging to the registered TAI, the old AMF includes the Unchecked NSSAI in the message to the new AMF. The new AMF stores the Unchecked NSSAI and updates the number of UE count during the PDU session establishment procedure for the S-NSSAI stored in the Unchecked NSSAI.

Here, the Serving PLMN (e.g., the AMF 70) sends the Allowed NSSAI (including e.g., S-NSSAI #1 and S-NSSAI #2) and the Unchecked NSSAI (including e.g., S-NSSAI #2) to the UE 3 in the Registration Accept message. The Allowed NSSAI may include S-NSSAI #1 and S-NSSAI #2. The Unchecked NSSAI may include S-NSSAI #2.

For example, in a case where the AMF 70 determines that S-NSSAI #2 is associated with the attribute “maximum number of UEs with at least one PDU session/PDN connection” in step 4 (or in a case where the AMF 70 performs Option A), the AMF 70 may send, to the UE 3, the Unchecked NSSAI which includes S-NSSAI #2.

In a case that the S-NSSAI #2 is subject to the NSSAA (or the NSSAA procedure), the Registration Accept message contains Allowed NSSAI set to (or including) S-NSSAI #1, Pending NSSAI set to (or including)S-NSSAI #2 and Unchecked NSSAI set to (or including)S-NSSAI #2. When the NSSAA procedure is finished successfully then the AMF 70 sends a configuration update command with the Allowed NSSAI set to S-NSSAI #1 and S-NSSAI #2 and, optionally, the Unchecked NSSAI set to S-NSSAI #2. Or when the NSSAA procedure is finished successfully then the AMF 70 may send a configuration update command with the Allowed NSSAI set to S-NSSAI #1 and the Unchecked NSSAI set to S-NSSAI #2. If the NSSAA procedure is unsuccessful, then the AMF 70 sends an extended rejected NSSAI set to S-NSSAI #2. When the UE 3 receives the configuration update command with the extended rejected NSSAI, the UE 3 removes the S-NSSAI #2 from the Unchecked NSSAI.

For example, in a case where the AMF 70 receives the Nnsacf_NSAC_NumOfUEsUpdate_Response message including information indicating that the maximum number of UEs registered for S-NSSAI #1 is reached, the AMF 70 may send the Registration Accept message including the Allowed NSSAI which includes S-NSSAI #2, the Rejected NSSAI which includes S-NSSAI #1 and/or the Unchecked NSSAI which includes S-NSSAI #2.

In a case where the AMF 70 determines that S-NSSAI #2 is associated with the attribute “maximum number of UEs with at least one PDU session/PDN connection” in step 4, the AMF 70 may include the Unchecked NSSAI which includes S-NSSAI #2 in the Registration Accept message.

In a case where the AMF 70 determines that S-NSSAI #2 is associated with the attribute “maximum number of UEs with at least one PDU session/PDN connection” in step 4, the AMF 70 may include the Allowed NSSAI which includes S-NSSAI #2 in the Registration Accept message.

For example, the AMF 70 may send the Registration Accept message including information indicating that the checking the count of the number of registered UEs 3 for S-NSSAI #2 is not performed in addition to or instead of sending the Unchecked NSSAI.

For example, the information indicating that the checking the count of the number of registered UEs 3 for S-NSSAI #2 is not performed may have same role to the Unchecked NSSAI in this disclosure.

### Option B

Step 5b: If it is assumed that two S-NSSAIs (e.g., S-NSSAI #1 and S-NSSAI #2) in the Requested NSSAI are associated with the same attribute “UEs registered to 5GS” and subject to NSAC, then both the slices (S-NSSAI #1 and S-NSSAI #2) are considered for the number of UEs registered per network slice availability check and update procedure in this case.

The AMF 70 uses an Nnsacf_NSAC_NumOfUEsUpdate_Request service operation to share the UE ID, the S-NSSAI(s) values, and Access Type information with the NSACF 77 to increase the number of UEs 3 registered with the same S-NSSAI(s).

For example, the AMF 70 may send an Nnsacf_NSAC_NumOfUEsUpdate_Request message including S-NSSAI #1 and S-NSSAI #2 to the NSACF 77.

Step 6b: The NSACF 77 checks the count of the number of registered UEs 3 per Network Slice (i.e., S-NSSAI), increases the count, and allows the UE 3 to use the same S-NSSAI if the count does not exceed a maximum limit. For example, the NSACF 77 may check the count of the number of registered UEs 3 for S-NSSAI #1 and S-NSSAI #2 and increase the count and allow the UE 3 to use S-NSSAI #1 and S-NSSAI #2 in a case where the count does not exceed the maximum limit. For example, the NSACF 77 may check the count of the number of registered UEs 3 for S-NSSAI #1 and S-NSSAI #2 and may not increase the count and may not allow the UE 3 to use S-NSSAI #1 and S-NSSAI #2 in a case where the count exceeds the maximum limit. The NSACF 77 may perform the NSAC for S-NSSAI #1 and S-NSSAI #2.

Step 7b: The NSACF 77 uses an Nnsacf_NSAC_NumOfUEsUpdate_Response service operation to inform to the AMF 70 of whether the limit of the maximum number of UEs 3 registered per Network Slice has been reached or not.

For example, the NSACF 77 may send the Nnsacf_NSAC_NumOfUEsUpdate_Response message including information indicating that the maximum number of UEs registered for S-NSSAI #1 is not reached in a case where the maximum number of UEs registered for S-NSSAI #1 is not reached.

For example, the NSACF 77 may send the Nnsacf_NSAC_NumOfUEsUpdate_Response message including information indicating that the maximum number of UEs registered for S-NSSAI #2 is not reached in a case where the maximum number of UEs registered for S-NSSAI #2 is not reached.

For example, the NSACF 77 may send the Nnsacf_NSAC_NumOfUEsUpdate_Response message including information indicating that the maximum number of UEs registered for S-NSSAI #1 is reached in a case where the maximum number of UEs registered for S-NSSAI #1 is reached.

For example, the NSACF 77 may send the Nnsacf_NSAC_NumOfUEsUpdate_Response message including information indicating that the maximum number of UEs registered for S-NSSAI #2 is reached in a case where the maximum number of UEs registered for S-NSSAI #2 is reached.

For example, the NSACF 77 may send the Nnsacf_NSAC_NumOfUEsUpdate_Response message including information indicating that the maximum number of UEs registered for S-NSSAI #1 is not reached and information indicating that the maximum number of UEs registered for S-NSSAI #2 is not reached in a case where the maximum number of UEs registered for S-NSSAI #1 is not reached and the maximum number of UEs registered for S-NSSAI #2 is not reached.

For example, the NSACF 77 may send the Nnsacf_NSAC_NumOfUEsUpdate_Response message including information indicating that the maximum number of UEs registered for S-NSSAI #1 is reached and information indicating that the maximum number of UEs registered for S-NSSAI #2 is reached in a case where the maximum number of UEs registered for S-NSSAI #1 is reached and the maximum number of UEs registered for S-NSSAI #2 is reached.

For example, the NSACF 77 may send the Nnsacf_NSAC_NumOfUEsUpdate_Response message including information indicating that the maximum number of UEs registered for S-NSSAI #1 is not reached and information indicating that the maximum number of UEs registered for S-NSSAI #2 is reached in a case where the maximum number of UEs registered for S-NSSAI #1 is not reached and the maximum number of UEs registered for S-NSSAI #2 is reached.

For example, the NSACF 77 may send the Nnsacf_NSAC_NumOfUEsUpdate_Response message including information indicating that the maximum number of UEs registered for S-NSSAI #1 is reached and information indicating that the maximum number of UEs registered for S-NSSAI #2 is not reached in a case where the maximum number of UEs registered for S-NSSAI #1 is reached and the maximum number of UEs registered for S-NSSAI #2 is not reached.

Step 8b: Upon reception of the response from the NSACF 77, the AMF 70 sends at least one of the Allowed NSSAI which indicates a set of S-NSSAIs which the UE 3 can use to access services from the serving PLMN in the current Registration Area and the Rejected NSSAI which indicates a set of S-NSSAIs which the UE 3 cannot use for accessing services. Here, the Serving PLMN (e.g., the AMF 70) sends the Allowed NSSAI (including e.g., S-NSSAI #1 and S-NSSAI #2) to the UE 3 in the Registration Accept message.

For example, the AMF 70 may send the Registration Accept message including the Allowed NSSAI which includes S-NSSAI #1 in a case where the AMF 70 receives, from the NSACF 77, the information indicating that the maximum number of UEs registered for S-NSSAI #1 is not reached.

For example, the AMF 70 may send the Registration Accept message including the Rejected NSSAI which includes S-NSSAI #1 in a case where the AMF 70 receives, from the NSACF 77, the information indicating that the maximum number of UEs registered for S-NSSAI #1 is reached.

For example, the AMF 70 may send the Registration Accept message including the Allowed NSSAI which includes S-NSSAI #2 in a case where the AMF 70 receives, from the NSACF 77, the information indicating that the maximum number of UEs registered for S-NSSAI #2 is not reached.

For example, the AMF 70 may send the Registration Accept message including the Rejected NSSAI which includes S-NSSAI #2 in a case where the AMF 70 receives, from the NSACF 77, the information indicating that the maximum number of UEs registered for S-NSSAI #2 is reached.

For example, the AMF 70 may send the Registration Accept message including the Allowed NSSAI which includes S-NSSAI #1 and S-NSSAI #2 in a case where the AMF 70 receives, from the NSACF 77, the information indicating that the maximum number of UEs registered for S-NSSAI #1 is not reached and the information indicating that the maximum number of UEs registered for S-NSSAI #2 is not reached.

For example, the AMF 70 may send the Registration Accept message including the Rejected NSSAI which includes S-NSSAI #1 and S-NSSAI #2 in a case where the AMF 70 receives, from the NSACF 77, the information indicating that the maximum number of UEs registered for S-NSSAI #1 is reached and the information indicating that the maximum number of UEs registered for S-NSSAI #2 is reached.

For example, the AMF 70 may send the Registration Accept message including the Allowed NSSAI which includes S-NSSAI #1 and the Rejected NSSAI which includes S-NSSAI #2 in a case where the AMF 70 receives, from the NSACF 77, the information indicating that the maximum number of UEs registered for S-NSSAI #1 is not reached and the information indicating that the maximum number of UEs registered for S-NSSAI #2 is reached.

For example, the AMF 70 may send the Registration Accept message including the Rejected NSSAI which includes S-NSSAI #1 and the Allowed NSSAI which includes S-NSSAI #2 in a case where the AMF 70 receives, from the NSACF 77, the information indicating that the maximum number of UEs registered for S-NSSAI #1 is reached and the information indicating that the maximum number of UEs registered for S-NSSAI #2 is not reached.

### Variant 1 of First Example of the First Aspect

In step 2 of the First example of the First Aspect in FIG. 1, the UE 3 provides the Requested NSSAI. In some cases, the UE 3 may not provide the Requested NSSAI. In that case, the network identifies a suitable S-NSSAI for the UE 3 and proceeds the Registration procedure.

### Second Example of the First Aspect

This example comprises a mechanism for configuring the SMF to be aware of Network Slice(s) with its attribute details, including the GSMA defined new attribute “maximum number of UEs with at least one PDU session/PDN connection” and the existing attribute “UEs registered to 5GS”, and performing the number of UEs per S-NSSAI availability check and update procedure for Network Slice(s) which matches the attribute “maximum number of UEs with at least one PDU session/PDN connection” and subject to NSAC during the PDU session establishment procedure.

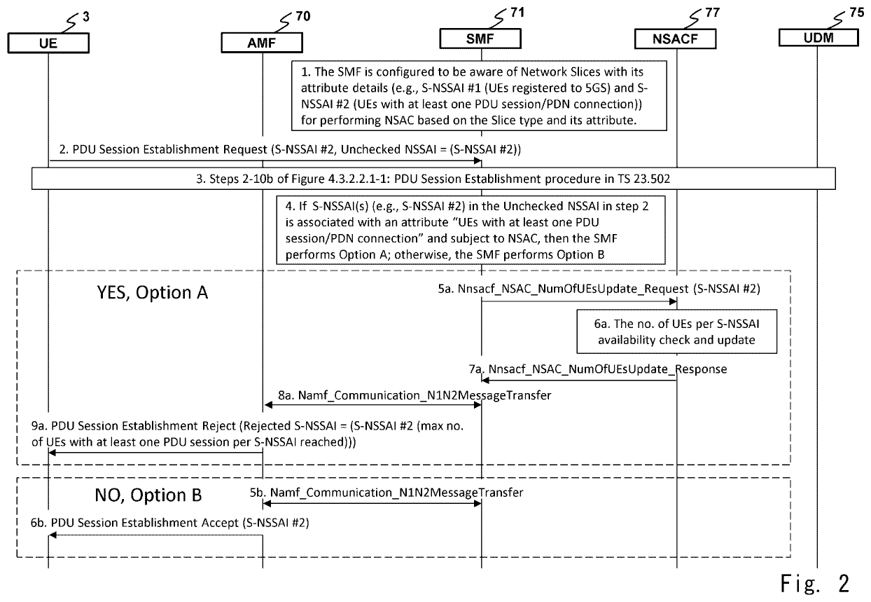

The detailed processes of the Second example of the First Aspect are described below with reference to FIG. 2. FIG. 2 shows a procedure for configuring the SMF to be aware of Network Slice(s) (S-NSSAI(s)) with different attributes and applying NSAC during a PDU session establishment procedure.

The processes of the Second example of the First Aspect may be performed after the processes of the First example of each Aspect. For example, the processes of the Second example of the First Aspect may be performed after the step 8a of the First example of the First Aspect.

Step 1: The SMF 71 is configured to be aware of Network Slice(s) (S-NSSAI(s)) with its attributes, such as UEs 3 registered to 5GS and UEs 3 with at least one PDU session or PDN connection, for performing NSAC based on the Slice type and its attribute. For example, S-NSSAI #1 (UEs registered to 5GS) and S-NSSAI #2 (UEs with at least one PDU session/PDN connection) are two Network Slices with specific attributes and they are subject to NSAC.

In this disclosure, for example, the SMF 71 may be configured to be aware of (or may be configured to determine, or may be configured to check) attributes for network slice(s) (or the S-NSSAI(s)).

In this disclosure, for example, the SMF 71 may be configured to be aware that S-NSSAI #1 has or is associated with the attribute “UEs registered to 5GS” and S-NSSAI #2 has or is associated with the attribute “maximum number of UEs with at least one PDU session/PDN connection”.

In this disclosure, for example, the SMF 71 may be aware or understand that S-NSSAI #1 has or is associated with the attribute “UEs registered to 5GS” and S-NSSAI #2 has or is associated with the attribute “maximum number of UEs with at least one PDU session/PDN connection”.

In this disclosure, for example, the SMF 71 may be configured by information related to the attributes (e.g., “UEs registered to 5GS” and “UEs with at least one PDU session/PDN connection”) per network slice (or S-NSSAI).

In this disclosure, for example, based on the information related to the attributes, the SMF 71 may determine which network slice (or S-NSSAI) has or is associated which attributes.

In this disclosure, for example, the SMF 71 may store the information related to the attributes in advance or may receive the information related to the attributes from other network node(s).

Step 2: A UE 3 provides S-NSSAI (e.g., S-NSSAI #2) and/or the Unchecked NSSAI (including e.g., S-NSSAI #2) to SMF 71 as part of a PDU session establishment request.

For example, the UE 3 may send a PDU session establishment request message including at least one S-NSSAI that the UE 3 wishes to establish the PDU session, and including the Unchecked NSSAI.

For example, the UE 3 may send a PDU session establishment request message including at least S-NSSAI #2 that the UE 3 wishes to establish the PDU session, and including the Unchecked NSSAI which includes S-NSSAI #2.

For example, the UE 3 may select S-NSSAI #2 from the Allowed NSSAI received in step 8a of FIG. 1.

For example, the UE 3 may select S-NSSAI #2 from at least one of the Allowed NSSAI and the Unchecked NSSAI received in step 8a of FIG. 1. S-NSSAI(s) included in the PDU session establishment request message may be included in at least one of the Allowed NSSAI and the Unchecked NSSAI received in step 8a of FIG. 1.

Step 2 can be separated into the following two parts.

The UE 3 may send a UL NAS Transport message to the AMF 70 including S-NSSAI (e.g., S-NSSAI #2), a Payload container and/or the Unchecked NSSAI (including e.g., S-NSSAI #2). The Payload container contains the PDU session establishment request message.

Upon reception of the UL NAS Transport message in the AMF 70, the AMF 70 may send an Nsmf_PDUSession_CreateSMContext Request message to the SMF 71 including the PDU session establishment request message and/or the Unchecked NSSAI (including e.g., S-NSSAI #2).

In one example, the PDU session establishment request message may include the Unchecked NSSAI (including e.g., S-NSSAI #2).

Optionally, if the Serving PLMN is not a UE's 3 Home PLMN, the UE 3 may include a Mapping of the Allowed NSSAI/Unchecked NSSAI which is the mapping of each S-NSSAI of the Allowed NSSAI/Unchecked NSSAI to the HPLMN S-NSSAIs.

The Unchecked NSSAI may not be included in the PDU session establishment request message. For example, in a case where the UE 3 does not receive the Unchecked NSSAI from the AMF 70 in step 8a of FIG. 1, the UE 3 may not send the Unchecked NSSAI.

For example, in a case where the UE 3 receives the information indicating that the checking the count of the number of registered UEs 3 for S-NSSAI #2 is not performed in step 8a of FIG. 1, the UE 3 may include the information in the PDU session establishment request message.

Step 3: Step 2 to step 10b of the FIG. 4.3.2.2.1-1: PDU Session Establishment procedure in TS 23.502 (NPL3) take place.

Step 4: The SMF 71 is configured with the information that indicates which Network Slice is subject to NSAC.

For example, the SMF 71 may determine whether S-NSSAI(s) (e.g., S-NSSAI #2) in the Unchecked NSSAI (or S-NSSAI(s) (e.g., S-NSSAI #2) in the PDU Session Establishment Request) in step 2 is associated with the attribute “maximum number of UEs with at least one PDU session/PDN connection”.

In addition, the SMF 71 may determine whether S-NSSAI(s) (e.g., S-NSSAI #2) in the Unchecked NSSAI (or S-NSSAI(s) (e.g., S-NSSAI #2) in the PDU Session Establishment Request) in step 2 is subject to NSAC.

If the S-NSSAI(s) (e.g., S-NSSAI #2) in the Unchecked NSSAI (or S-NSSAI(s) (e.g., S-NSSAI #2) in the PDU Session Establishment Request) in step 2 is associated with the attribute “maximum number of UEs with at least one PDU session/PDN connection” and subject to NSAC (e.g., in a case where the SMF 71 determines that S-NSSAI(s) (e.g., S-NSSAI #2) in the Unchecked NSSAI (or S-NSSAI(s) (e.g., S-NSSAI #2) in the PDU Session Establishment Request) in step 2 is associated with the attribute “maximum number of UEs with at least one PDU session/PDN connection” and/or subject to NSAC), then the SMF 71 performs Option A in FIG. 2. Otherwise, the SMF 71 performs Option B in FIG. 2.

For example, the SMF 71 may determine whether S-NSSAI #2 in the PDU Session Establishment Request is associated with the attribute “maximum number of UEs with at least one PDU session/PDN connection” and/or subject to NSAC in a case where the SMF 71 does not receive the Unchecked NSSAI.

For example, the SMF 71 may determine whether S-NSSAI #2 in the PDU Session Establishment Request is associated with the attribute “maximum number of UEs with at least one PDU session/PDN connection” and/or subject to NSAC in a case where the SMF 71 receive the information indicating that the checking the count of the number of registered UEs 3 for S-NSSAI #2 is not performed.

The SMF 71 triggers the number of UEs per network slice availability check and update procedure to update the number of UEs registered for an S-NSSAI with the attribute “maximum number of UEs with at least one PDU session/PDN connection” and subject to NSAC. The SMF 71 may perform the number of UEs per network slice availability check and update procedure by using an Nnsacf_NSAC_NumOfUEsUpdate_Request service operation or by sending an Nnsacf_NSAC_NumOfUEsUpdate_Request message in this disclosure.

For example, in a case where S-NSSAI #2 is subject to NSAC and/or S-NSSAI #2 is associated with the attribute “maximum number of UEs with at least one PDU session/PDN connection”, the SMF 71 may perform Option A in FIG. 2.

For example, in a case where S-NSSAI #2 is subject to NSAC and/or is associated with the attribute “UEs registered to 5GS”, the SMF 71 may perform Option B in FIG. 2.

There may be multiple NSACFs 77 for different S-NSSAIs which are subject to NSAC and thus the SMF 71 triggers the number of UEs per network slice availability check and update request to multiple NSACFs 77.

### Option A

Step 5a: The SMF 71 selects S-NSSAI(s) (e.g., S-NSSAI #2) which is in the Unchecked NSSAI (or which is in the PDU session establishment request message) and is associated with the attribute “maximum number of UEs with at least one PDU session/PDN connection” and subject to NSAC.

The SMF 71 uses an Nnsacf_NSAC_NumOfUEsUpdate_Request service operation to share the UE ID, the PDU session ID, the S-NSSAI(s) value(s), and Access Type information with an NSACF 77 to increase the number of UEs 3 registered with the same S-NSSAI(s).

For example, the SMF 71 may send an Nnsacf_NSAC_NumOfUEsUpdate_Request message including S-NSSAI #2 to the NSACF 77.

For example, in a case where the SMF 71 does not receive the Unchecked NSSAI from the UE 3, the SMF 71 may determine whether S-NSSAI #2 included in the PDU session establishment request message has or is associated with the attribute “maximum number of UEs with at least one PDU session/PDN connection” based on the configuration mentioned in step 1. In a case where the SMF 71 determine that S-NSSAI #2 has or is associated with the attribute “maximum number of UEs with at least one PDU session/PDN connection”, the SMF 71 may send the Nnsacf_NSAC_NumOfUEsUpdate_Request message including S-NSSAI #2 to the NSACF 77.

For example, in a case where the SMF 71 receives the information indicating that the checking the count of the number of registered UEs 3 for S-NSSAI #2 is not performed, the SMF 71 may determine whether S-NSSAI #2 included in the PDU session establishment request message has or is associated with the attribute “maximum number of UEs with at least one PDU session/PDN connection” based on the configuration mentioned in step 1. In a case where the SMF 71 determine that S-NSSAI #2 has or is associated with the attribute “maximum number of UEs with at least one PDU session/PDN connection”, the SMF 71 may send the Nnsacf_NSAC_NumOfUEsUpdate_Request message including S-NSSAI #2 to the NSACF 77.

Step 6a: The NSACF 77 checks the count of the number of registered UEs 3 per Network Slice (i.e., S-NSSAI), increases the count, and allows the UE 3 to use the same S-NSSAI if the count does not exceed a maximum limit.

For example, in a case where the NSACF 77 receives the Nnsacf_NSAC_NumOfUEsUpdate_Request message including S-NSSAI #2 from the SMF 71. The NSACF 77 may check the count of the number of registered UEs 3 for S-NSSAI #2.

For example, the NSACF 77 may check the count of the number of registered UEs 3 for S-NSSAI #2, and increase the count and allow the UE 3 to use S-NSSAI #2 in a case where the count does not exceed the maximum limit.

For example, the NSACF 77 may check the count of the number of registered UEs 3 for S-NSSAI #2, and may not increase the count and may not allow the UE 3 to use S-NSSAI #2 in a case where the count exceeds the maximum limit.

Step 7a: The NSACF 77 uses an Nnsacf_NSAC_NumOfUEsUpdate_Response service operation to inform to the SMF 71 of whether the limit of the maximum number of UEs 3 registered per Network Slice has been reached or not.

For example, the NSACF 77 may send an Nnsacf_NSAC_NumOfUEsUpdate_Response message including information indicating that the maximum number of UEs registered for S-NSSAI #2 is not reached in a case where the maximum number of UEs registered for S-NSSAI #2 is not reached.

For example, the NSACF 77 may send the Nnsacf_NSAC_NumOfUEsUpdate_Response message including information indicating that the maximum number of UEs registered for S-NSSAI #2 is reached in a case where the maximum number of UEs registered for S-NSSAI #2 is reached.

Step 8a: Upon reception of the response from the NSACF 77, the SMF 71 sends to the AMF 70 either a PDU Session Establishment Accept message by including an S-NSSAI from the Unchecked NSSAI received in step 3 or a PDU Session Establishment Reject message with a cause indicating that “maximum number of UEs with at least one PDU session per S-NSSAI is reached”. The cause may indicate that the maximum number of UEs with at least one PDU session/PDN connection per S-NSSAI is reached.

For example, the SMF 71 may send the PDU Session Establishment Accept message including S-NSSAI #2.

For example, the SMF 71 may send the PDU Session Establishment Accept message including S-NSSAI #2 in a case where the response from the NSACF 77 includes the information indicating that the maximum number of UEs registered for S-NSSAI #2 is not reached.

For example, the SMF 71 may send the PDU Session Establishment Reject message including S-NSSAI #2.

For example, the PDU Session Establishment Reject message may include the cause indicating that “maximum number of UEs with at least one PDU session per S-NSSAI is reached”.

For example, the SMF 71 may send the PDU Session Establishment Reject message including S-NSSAI #2 with the cause indicating that “maximum number of UEs with at least one PDU session per S-NSSAI is reached”.

For example, the cause may be expressed as a cause value or reject cause in this disclosure.

For example, the SMF 71 may send the PDU Session Establishment Reject message including S-NSSAI #2 in a case where the response from the NSACF 77 includes the information indicating that the maximum number of UEs registered for S-NSSAI #2 is reached.

The sending the PDU Session Establishment Accept message and the sending PDU Session Establishment Reject message may be performed by using Namf_Communication_N1N2MessageTransfer.

Step 9a: The AMF 70 sends the received message from the SMF 71 to the UE 3. Here, the AMF 70 sends the PDU Session Establishment Reject message including Rejected S-NSSAI (e.g., S-NSSAI #2) with the cause that “maximum number of UEs with at least one PDU session per S-NSSAI is reached”.

The AMF 70 may send, to the UE 3, the PDU Session Establishment Accept message in a case where the AMF 70 receives the PDU Session Establishment Accept message from the SMF 71.

The AMF 70 may send, to the UE 3, the PDU Session Establishment Reject message in a case where the AMF 70 receives the PDU Session Establishment Reject message from the SMF 71.

### Option B

Step 5b: If S-NSSAI(s) (e.g., S-NSSAI #2) is associated with the attribute “UEs registered to 5GS” and the number of UEs for the S-NSSAI(s) (e.g., S-NSSAI #2) has been already counted in the Registration procedure or if S-NSSAI(s) (e.g., S-NSSAI #2) is not subject to NSAC, then the S-NSSAI(s) is considered in this case and they are not subject to NSAC again.

The SMF 71 sends to the AMF 70 either the PDU Session Establishment Accept message by including an S-NSSAI from the Allowed NSSAI received in step 3, or the PDU Session Establishment Reject message with the cause if the PDU session establishment failed in step 3. The cause may indicate that establishing the PDU session failed.

For example, in a case where the SMF 71 determines that S-NSSAI #2 has or is associated with the attribute “UEs registered to 5GS” based on the configuration mentioned in step 1, the SMF 71 may not perform the Nnsacf_NSAC_NumOfUEsUpdate_Response service operation for S-NSSAI #2.

Then, the SMF 71 may send to the AMF 70 the PDU Session Establishment Accept message including S-NSSAI #2 in a case where the PDU session establishment completed successfully in step 3.

The SMF 71 may send to the AMF 70 the PDU Session Establishment Reject message including S-NSSAI #2 in a case where the PDU session establishment failed in step 3.

The sending the PDU Session Establishment Accept message and the sending PDU Session Establishment Reject message may be performed by using Namf_Communication_N1N2MessageTransfer.

Step 6b: The AMF 70 sends the received message from the SMF 71 to the UE 3. Here, the AMF 70 sends the PDU Session Establishment Accept message with an S-NSSAI value (e.g., S-NSSAI #2).

The AMF 70 may send, to the UE 3, the PDU Session Establishment Accept message in a case where the AMF 70 receives the PDU Session Establishment Accept message from the SMF 71.

The AMF 70 may send, to the UE 3, the PDU Session Establishment Reject message in a case where the AMF 70 receives the PDU Session Establishment Reject message from the SMF 71.

### Variant 1 of Second Example of the First Aspect

In step 2 of the Second example of the First Aspect in FIG. 2, the UE 3 provides the S-NSSAI and/or the Unchecked NSSAI. In some cases, the UE 3 may not provide the S-NSSAI and/or the Unchecked NSSAI. In that case, the network identifies a suitable S-NSSAI for the UE 3 and proceeds with the PDU session establishment procedure.

### Variant 2 of Second Example of the First Aspect

In step 1 of the Second example of the First Aspect in FIG. 2, the SMF 71 is configured to be aware of the Network Slice(s) with its attribute details for performing/triggering NSAC based on the Slice type and its attribute. Since the AMF 70 maintains the configuration data usually as the control signaling node, the AMF 70 can be configured in step 1 to be aware of the Network Slice(s) with its attribute details for performing/triggering NSAC instead of the SMF 71. In this case, the configuration details of S-NSSAI(s) in the Allowed NSSAI and/or the Unchecked NSSAI can be shared with the SMF 71 by the AMF 70 for performing/triggering the number of UEs per network slice availability check and update procedure. Then, the same procedure from step 5 described in the Second example of the First Aspect in FIG. 2 will take place. The configuration details of S-NSSAI(s) may include information indicating the attribute per Network slice(s) (e.g., S-NSSAI(s)). The configuration details of S-NSSAI(s) may include information indicating that S-NSSAI #1 has or is associated with the attribute “UEs registered to 5GS” and information indicating that S-NSSAI #1 has or is associated with the attribute “maximum number of UEs with at least one PDU session/PDN connection”.

For example, the AMF 70 may send the configuration details of S-NSSAI(s) to the SMF 71 by using existing message(s) or new message(s) between the AMF 70 and the SMF 71. Then, the SMF 71 may perform the process(es) in step 4 based on the received configuration details of S-NSSAI(s).

According to this variant, the SMF 71 can perform the process(es) in step 4 based on the received configuration details of S-NSSAI(s) in a case where the SMF 71 is not configured to be aware of Network Slice(s) (S-NSSAI(s)) with its attributes.

### Variant 3 of Second Example of the First Aspect

In step 7a, if the SMF 71 receives the Nnsacf_NSAC_NumOfUEsUpdate_Response message indicating that the update request for a number of UEs is successful (e.g., in a case where the SMF 71 receives the response from the NSACF 77 including the information which indicates that the maximum number of UEs registered for S-NSSAI #2 is not reached), the SMF 71 may include S-NSSAI #2 in the Checked NSSAI in the PDU Session Establishment Accept message and send it to the UE 3 via the AMF 70.

For example, in a case where the SMF 71 receives the response from the NSACF 77 including the information which indicates that the maximum number of UEs registered for S-NSSAI #2 is reached, the SMF 71 may include S-NSSAI #2 to Checked NSSAI in the PDU Session Establishment Accept message and send it to the UE 3 via the AMF 70.

When the UE 3 receives S-NSSAI #2 in the Checked NSSAI, the UE 3 removes S-NSSAI #2 from the Unchecked NSSAI in a storage of the UE 3.

The Checked NSSAI may indicate a set of S-NSSAIs which has been checked with the NSACF 77 during the PDU session establishment procedure.

### Variant 4 of Second Example of the First Aspect

During the procedure in FIG. 2, the SMF 71 may perform the Number of PDU Sessions per network slice availability check and update procedure.

For example, in a case where the SMF 71 receives, from the NSACF 77, the response indicating that the number of UEs registered for S-NSSAI #2 is not reached the maximum limit in step 7a, the SMF 71 may perform the Number of PDU Sessions per network slice availability check and update procedure to update (i.e., increase or decrease) the number of PDU Sessions established on S-NSSAI #2.

For example, in a case where the SMF 71 receives, from the NSACF 77, the response indicating that the number of UEs registered for S-NSSAI #2 is reached the maximum limit in step 7a, the SMF 71 may not perform the Number of PDU Sessions per network slice availability check and update procedure for S-NSSAI #2. In a case where the SMF 71 does not perform the Number of PDU Sessions per network slice availability check and update procedure for S-NSSAI #2, the SMF 71 may perform the process(es) in step 8a of FIG. 2.

For example, in the Number of PDU Sessions per network slice availability check and update procedure, the SMF 71 may use the Nnsacf_NSAC_NumOfPDUsUpdate_Request service operation for S-NSSAI #2 (e.g., the SMF 71 may send the Nnsacf_NSAC_NumOfPDUsUpdate_Request message including S-NSSAI #2 to the NSACF 77).

For example, upon reception of the Nnsacf_NSAC_NumOfPDUsUpdate_Request message, the NSACF 77 may check the count of the number of PDU Sessions for S-NSSAI #2, and increase the count and allow the UE 3 to use S-NSSAI #2 in a case where the count does not exceed the maximum limit. Then, the NSACF 77 may use the Nnsacf_NSAC_NumOfPDUsUpdate_Response service operation to inform to the SMF 71 whether the maximum number of PDU Sessions established on S-NSSAI #2 is reached or not. The limit of the maximum number of PDU Sessions may be expressed as the maximum number of PDU Sessions.

For example, the NSACF 77 may send, to the SMF 71, the Nnsacf_NSAC_NumOfPDUsUpdate_Response message including information which indicates that the maximum number of PDU Sessions established on S-NSSAI #2 is reached in a case where the maximum number of PDU Sessions established on S-NSSAI #2 is reached.

For example, the NSACF 77 may send, to the SMF 71, the Nnsacf_NSAC_NumOfPDUsUpdate_Response message including information which indicates that the maximum number of PDU Sessions established on S-NSSAI #2 is not reached in a case where the maximum number of PDU Sessions established on S-NSSAI #2 is not reached.

Upon reception of the response from the NSACF 77, the SMF 71 may send to the AMF 70 either a PDU Session Establishment Accept message including S-NSSAI #2 or a PDU Session Establishment Reject message with the cause that “maximum number of UEs with at least one PDU session per S-NSSAI is reached”. The AMF 70 may send the received PDU Session Establishment Accept message or the received PDU Session Establishment Reject message to the UE 3.

For example, the SMF 71 may send the PDU Session Establishment Accept message including S-NSSAI #2.

For example, the SMF 71 may send the PDU Session Establishment Accept message including S-NSSAI #2 in a case where the response from the NSACF 77 includes the information indicating that the maximum number of PDU Sessions established on S-NSSAI #2 is not reached.

For example, the SMF 71 may send the PDU Session Establishment Reject message including S-NSSAI #2.

For example, the PDU Session Establishment Reject message may include the cause indicating that the maximum number of PDU Sessions established on S-NSSAI #2 is reached.

For example, the SMF 71 may send the PDU Session Establishment Reject message including S-NSSAI #2 with the cause indicating that the maximum number of PDU Sessions established on S-NSSAI #2 is reached.

For example, the SMF 71 may send the PDU Session Establishment Reject message including S-NSSAI #2 in a case where the response from the NSACF 77 includes the information indicating that the maximum number of PDU Sessions established on S-NSSAI #2 is reached.

For example, the SMF 71 may perform the Number of PDU Sessions per network slice availability check and update procedure in case of Option B.

### Variant 5 of Second Example of the First Aspect

The SMF 71 may use an Nnsacf_NSAC_NumOfPDUsUpdate_Request service operation instead of using the Nnsacf_NSAC_NumOfUEsUpdate_Request service operation. For example, the SMF 71 may send an Nnsacf_NSAC_NumOfPDUsUpdate_Request message including S-NSSAI #2 and/or the Unchecked NSSAI which includes S-NSSAI #2 in step 5a.

For example, in a case where the NSACF 77 receives the Nnsacf_NSAC_NumOfPDUsUpdate_Request message including S-NSSAI #2 and/or the Unchecked NSSAI, the NSACF 77 may check the count of the number of registered UEs 3 for S-NSSAI #2 (e.g., S-NSSAI #2 included in the Unchecked NSSAI), and increase the count and allow the UE 3 to use S-NSSAI #2 in a case where the count does not exceed the maximum limit. The NSACF 77 may not increase the count and may not allow the UE 3 to use S-NSSAI #2 in a case where the count exceeds the maximum limit.

In addition, the NSACF 77 may perform the Number of PDU Sessions per network slice availability check and update procedure in a case where the NSACF 77 receives the Nnsacf_NSAC_NumOfPDUsUpdate_Request message including S-NSSAI #2 and/or the Unchecked NSSAI.

For example, the NSACF 77 may check the count of the number of registered UEs 3 for S-NSSAI #2, and increase the count and allow the UE 3 to use S-NSSAI #2 in a case where the count does not exceed the maximum limit, then the NSACF 77 may check the count of number of PDU sessions established on S-NSSAI #2.

For example, the NSACF 77 may include, in an Nnsacf_NSAC_NumOfPDUsUpdate_Response message, information indicating whether the maximum number of UEs registered for S-NSSAI #2 is reached and information indicating whether the maximum number of PDU sessions established on S-NSSAI #2 is reached based on results of the checking the count for the number of registered UEs 3 and the count for the number of PDU sessions established on S-NSSAI(s).

For example, the NSACF 77 may send, to the SMF 71, the Nnsacf_NSAC_NumOfPDUsUpdate_Response message including at least one of the information indicating that the maximum number of UEs registered for S-NSSAI #2 is not reached and information indicating that the maximum number of PDU sessions established on S-NSSAI #2 is not reached in a case where the maximum number of UEs registered for S-NSSAI #2 is not reached and the maximum number of PDU sessions established on S-NSSAI #2 is not reached.

For example, the NSACF 77 may send, to the SMF 71, the Nnsacf_NSAC_NumOfPDUsUpdate_Response message including at least one of the information indicating that the maximum number of UEs registered for S-NSSAI #2 is reached and information indicating that the maximum number of PDU sessions established on S-NSSAI #2 is reached in a case where the maximum number of UEs registered for S-NSSAI #2 is reached and the maximum number of PDU sessions established on S-NSSAI #2 is reached.

For example, the NSACF 77 may send, to the SMF 71, the Nnsacf_NSAC_NumOfPDUsUpdate_Response message including at least one of the information indicating that the maximum number of UEs registered for S-NSSAI #2 is reached and information indicating that the maximum number of PDU sessions established on S-NSSAI #2 is not reached in a case where the maximum number of UEs registered for S-NSSAI #2 is reached and the maximum number of PDU sessions established on S-NSSAI #2 is not reached.

For example, the NSACF 77 may send, to the SMF 71, the Nnsacf_NSAC_NumOfPDUsUpdate_Response message including at least one of the information indicating that the maximum number of UEs registered for S-NSSAI #2 is not reached and information indicating that the maximum number of PDU sessions established on S-NSSAI #2 is reached in a case where the maximum number of UEs registered for S-NSSAI #2 is not reached and the maximum number of PDU sessions established on S-NSSAI #2 is reached.

For example, the SMF 71 may send the PDU Session Establishment Accept message including S-NSSAI #2 in a case where the response from the NSACF 77 includes the information indicating that the maximum number of UEs registered for S-NSSAI #2 is not reached and the information indicating that the maximum number of PDU sessions established on S-NSSAI #2 is not reached.

For example, the SMF 71 may send the PDU Session Establishment Reject message including S-NSSAI #2 in a case where the response from the NSACF 77 includes at least one of the information indicating that the maximum number of UEs registered for S-NSSAI #2 is reached and the information indicating that the maximum number of PDU sessions established on S-NSSAI #2 is reached.

Instead of or in addition to the Unchecked NSSAI, the SMF 71 may include a request to perform the number of UEs per S-NSSAI availability check and update procedure for S-NSSAI #2 in the Nnsacf_NSAC_NumOfPDUsUpdate_Request message. In a case where the NSACF 77 receives the request, the NSACF 77 may check the count of the number of registered UEs 3 for S-NSSAI #2.

### Variant 6 of Second Example of the First Aspect

The SMF 71 may include the Unchecked NSSAI which includes S-NSSAI #2 in the Nnsacf_NSAC_NumOfUEsUpdate_Request message.

For example, the NSACF 77 may check the count of the number of registered UEs 3 for S-NSSAI #2 in a case where the NSACF 77 receives the Unchecked NSSAI including S-NSSAI #2 from the SMF 71.

Instead of or in addition to the Unchecked NSSAI, the SMF 71 may include a request to perform the number of UEs per S-NSSAI availability check and update procedure for S-NSSAI #2 in the Nnsacf_NSAC_NumOfPDUsUpdate_Request message. In a case where the NSACF 77 receives the request, the NSACF 77 may check the count of the number of registered UEs 3 for S-NSSAI #2.

In order to distinguish the Nnsacf_NSAC_NumOfUEsUpdate_Request message from the AMF 70 and the Nnsacf_NSAC_NumOfUEsUpdate_Request message from the SMF 71, the SMF 71 may include, in the Nnsacf_NSAC_NumOfUEsUpdate_Request message, information indicating that the Nnsacf_NSAC_NumOfUEsUpdate_Request message is sent from the SMF 71.

In a case where the NSACF 77 receives the information indicating that the Nnsacf_NSAC_NumOfUEsUpdate_Request message is sent from the SMF 71, the NSACF 77 may check the count of the number of registered UEs 3 for S-NSSAI #2.

For example, the information indicating that the Nnsacf_NSAC_NumOfUEsUpdate_Request message is sent from the SMF 71 may be expressed as information indicating that the Nnsacf_NSAC_NumOfUEsUpdate_Request message is not sent from the AMF 70.

For example, instead of the information indicating that the Nnsacf_NSAC_NumOfUEsUpdate_Request message is sent from the SMF 71, information indicating that the Nnsacf_NSAC_NumOfUEsUpdate_Request message is sent during the PDU session establishment procedure may be used.

### Variant 7 of Second Example of the First Aspect

The SMF 71 may include the Unchecked NSSAI which includes S-NSSAI #2 in the Nnsacf_NSAC_NumOfUEsUpdate_Request message.

For example, the NSACF 77 may check the count of the number of registered UEs 3 for S-NSSAI #2 in a case where the NSACF 77 receives the Unchecked NSSAI including S-NSSAI #2 from the SMF 71.

In a case where the NSACF 77 determines that the count of the number of registered UEs 3 for S-NSSAI #2 does not exceed the maximum limit, the NSACF 77 may perform the Number of PDU Sessions per network slice availability check and update procedure (e.g., the NSACF 77 may check the count of number of PDU

Sessions for S-NSSAI #2). Based on results of the checking the count of the number of PDU Sessions for S-NSSAI #2, the NSACF 77 may perform process(es) mentioned in Variant 4 of Second example of the First Aspect.

### Second Aspect

This aspect comprises a mechanism to support the GSMA defined new attribute “maximum number of UEs with at least one PDU session/PDN connection” per Network Slice by configuring the NSACF to be aware of Network Slice(s) which has the attribute of “maximum number of UEs with at least one PDU session/PDN connection” for monitoring and limiting the UEs count in a uniform manner.

For example, this aspect comprises a mechanism to support the GSMA defined new attribute “maximum number of UEs with at least one PDU session/PDN connection” per Network Slice which can be used by UEs (both 5GS and EPS UEs) simultaneously by configuring the NSACF to be aware of Network Slice(s) which has the attribute of “maximum number of UEs with at least one PDU session/PDN connection” for monitoring and limiting the UEs count in a uniform manner.

### First Example of the Second Aspect

This example comprises a mechanism for performing the number of UEs per S-NSSAI availability check and update procedure by configuring NSACF to maintain the new attribute “maximum number of UEs with at least one PDU session/PDN connection” per Network Slice basis during the Registration procedure.

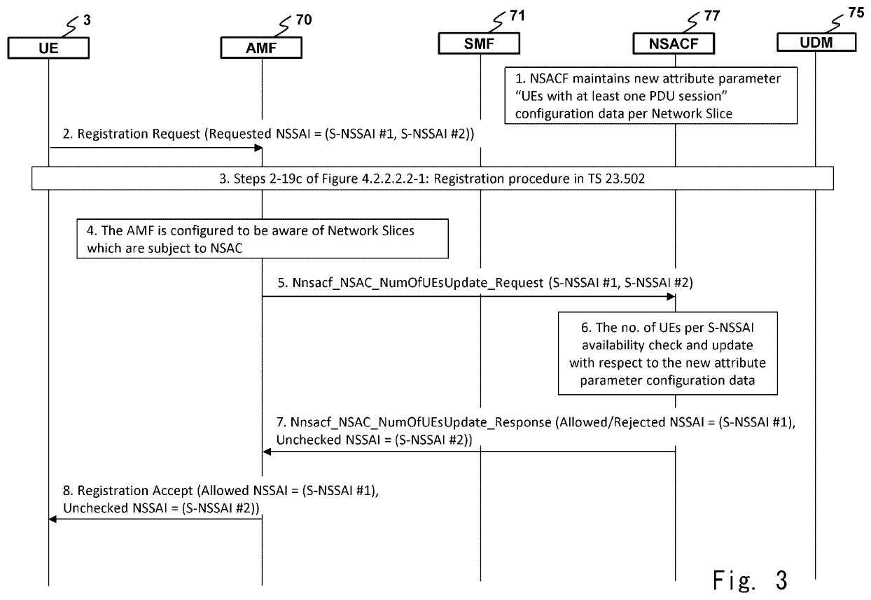

The detailed processes of the First example of the Second Aspect are described below with reference to FIG. 3. FIG. 3 shows a procedure for configuring the NSACF to be aware of Network Slice(s) (S-NSSAI(s)) with the new attribute “maximum number of UEs with at least one PDU session/PDN connection” and applying NSAC during a Registration procedure.

Step 1: An NSACF 77 is configured to be aware of Network Slice(s) (S-NSSAI(s)) with the new attribute “maximum number of UEs with at least one PDU session/PDN connection” configuration data for performing NSAC based on the Slice type and its attribute.

In this disclosure, for example, the NSACF 77 may be configured to be aware of (or may be configured to determine) attributes for network slice(s) (or the S-NSSAI(s)).

In this disclosure, for example, the NSACF 77 may be configured to be aware that S-NSSAI #1 has or is associated with the attribute “UEs registered to 5GS” and S-NSSAI #2 has or is associated with the attribute “maximum number of UEs with at least one PDU session/PDN connection”.

In this disclosure, for example, the NSACF 77 may be aware or understand that S-NSSAI #1 has or is associated with the attribute “UEs registered to 5GS” and S-NSSAI #2 has or is associated with the attribute “maximum number of UEs with at least one PDU session/PDN connection”.

In this disclosure, for example, the NSACF 77 may be configured by information related to the attributes (e.g., “UEs registered to 5GS” and “UEs with at least one PDU session/PDN connection”) per network slice (or S-NSSAI).

In this disclosure, for example, based on the information related to the attributes, the NSACF 77 may determine which network slice (or S-NSSAI) has or is associated which attributes.

In this disclosure, for example, the NSACF 77 may store the information related to the attributes in advance or may receive the information related to the attributes from other network node(s).

For the case of Network Slice(s) with the attribute “maximum number of UEs with at least one PDU session/PDN connection”, a UE 3 registered in a 5GS Network Slice with no PDU session established is not counted. Also, the new attribute “maximum number of UEs with at least one PDU session/PDN connection” is not used together with the attribute “maximum number of UEs”.

Step 2: NSSAI is a collection of S-NSSAIs. Requested NSSAI is NSSAI provided by the UE 3 to the Serving PLMN during a registration procedure. Here, the UE 3 provides Requested NSSAI to an AMF 70 as part of the Registration Request and the Requested NSSAI includes two S-NSSAIs (S-NSSAI #1 and S-NSSAI #2).

For example, the UE 3 may send the Registration Request message including the Requested NSSAI which includes S-NSSAI #1 and S-NSSAI #2. This step 2 may be the same as the step 2 in FIG. 1.

Optionally, if the Serving PLMN is not a UE 3's Home PLMN, then the UE 3 may include a Mapping of Requested NSSAI which is the mapping of each S-NSSAI of the Requested NSSAI to the HPLMN S-NSSAIS.

Step 3: Step 2 to step 19c of the FIG. 4.2.2.2.2-1: Registration procedure in TS 23.502 (NPL3) take place.

Step 4: The AMF 70 is configured with the information that indicates which Network Slice is subject to NSAC. If an S-NSSAI(s) in the Requested NSSAI is subject to NSAC irrespective of their attribute parameter, then the AMF 70 performs the number of UEs registered per network slice availability check and update procedure.

There may be multiple NSACFs 77 for different S-NSSAIs which are subject to NSAC and thus the AMF 70 triggers the number of UEs per network slice availability check and update request to multiple NSACFs 77.

Step 5: The AMF 70 uses an Nnsacf_NSAC_NumOfUEsUpdate_Request service operation to share the UE ID, the S-NSSAI(s) values, and Access Type information with the NSACF 77 to increase the number of UEs 3 registered with the same S-NSSAI(s).

For example, the AMF 70 may send an Nnsacf_NSAC_NumOfUEsUpdate_Request message including S-NSSAI #1 and S-NSSAI #2 to the NSACF 77.

Step 6: With the available new attribute configuration data, the NSACF 77 can identify Network Slice(s) which is associated with the new attribute “maximum number of UEs with at least one PDU session/PDN connection” and include them in the Unchecked NSSAI as a PDU session(s) is not yet established for them. Step 6 may be triggered by the reception of the Nnsacf_NSAC_NumOfUEsUpdate_Request message from the AMF 70.

Network Slice(s) which is associated with the existing attribute “UEs registered to 5GS” are considered for NSAC at this stage. The NSACF 77 checks the count of the number of registered UEs 3 per Network Slice which is associated with the existing attribute, increases the count, and allows the UE 3 to use the same S-NSSAI if the count does not exceed a maximum limit.

For example, the NSACF 77 may determine whether the received S-NSSAI(s) is associated with the attribute “UEs registered to 5GS” or the attribute “maximum number of UEs with at least one PDU session/PDN connection”.

In this case, as S-NSSAI #1 is associated with the attribute “UEs registered to 5GS”, then the NSACF 77 may check the count of the number of registered UEs 3 for S-NSSAI #1, and increase the count and allow the UE 3 to use S-NSSAI #1 in a case where the count does not exceed the maximum limit. For example, the NSACF 77 may not increase the count and may not allow the UE 3 to use S-NSSAI #1 in a case where the count exceeds the maximum limit.

For example, in this case, as S-NSSAI #2 has the attribute “maximum number of UEs with at least one PDU session/PDN connection”, then the NSACF 77 may not check the count of the number of registered UEs 3 for S-NSSAI #2.

For example, in a case where the NSACF 77 determines that S-NSSAI #2 has the attribute “maximum number of UEs with at least one PDU session/PDN connection” and the received Nnsacf_NSAC_NumOfUEsUpdate_Request message does not include the Unchecked NSSAI which includes S-NSSAI #2, the NSACF 77 may not check the count of the number of registered UEs 3 for S-NSSAI #2.

For example, in a case where the NSACF 77 determines that S-NSSAI #2 has the attribute “maximum number of UEs with at least one PDU session/PDN connection” and the received Nnsacf_NSAC_NumOfUEsUpdate_Request message includes the Unchecked NSSAI which includes S-NSSAI #2, the NSACF 77 may check the count of the number of registered UEs 3 for S-NSSAI #2 or the NSACF 77 may not check the count of number of registered UEs 3 for S-NSSAI #2.

The Unchecked NSSAI may be defined by the descriptions in the First Aspect or by the descriptions in the Second Aspect or other Aspects.

For example, in a case where the NSACF 77 determines that S-NSSAI #2 has the attribute “maximum number of UEs with at least one PDU session/PDN connection”, the NSACF 77 may determine whether PDU session(s) on S-NSSAI #2 is established for the UE 3. For example, in a case where the NSACF 77 manages established PDU session(s) on S-NSSAI #2 by using UE ID, the NSACF 77 may determine whether the PDU session(s) on S-NSSAI #2 is established for the UE 3 by using the UE ID which is included in the received Nnsacf_NSAC_NumOfUEsUpdate_Request message (e.g., the UE ID which identifies the UE 3). In a case where the NSACF 77 determines that the PDU session(s) on S-NSSAI #2 is not established for the UE 3, the NSACF 77 may not check the count of the number of registered UEs 3 for S-NSSAI #2. In a case where the NSACF 77 determines that the PDU session(s) on S-NSSAI #2 is established for the UE 3, the NSACF 77 may check the count of number of registered UEs 3 for S-NSSAI #2.

For example, in a case where the NSACF 77 receives the Nnsacf_NSAC_NumOfUEsUpdate_Request message including S-NSSAI #2 from the AMF 70 and the NSACF 77 determines that S-NSSAI #2 is associated with the attribute “maximum number of UEs with at least one PDU session/PDN connection”, the NSACF 77 may not check the count of the number of registered UEs 3 for S-NSSAI #2.

For example, in a case where the NSACF 77 receives the Nnsacf_NSAC_NumOfUEsUpdate_Request message including S-NSSAI #1 from the AMF 70 and the NSACF 77 determines that S-NSSAI #1 is associated with the attribute “UEs registered to 5GS”, the NSACF 77 may check the count of the number of registered UEs 3 for S-NSSAI #1.

For example, the NSACF 77 may determine that the Nnsacf_NSAC_NumOfUEsUpdate_Request message is sent in the registration procedure in a case where the NSACF 77 receives the Nnsacf_NSAC_NumOfUEsUpdate_Request message from the AMF 70.

In a case where the NSACF 77 determines that the Nnsacf_NSAC_NumOfUEsUpdate_Request message is sent in the registration procedure, the NSACF 77 may determine whether S-NSSAI(s) included in the Nnsacf_NSAC_NumOfUEsUpdate_Request message is associated with the attribute “UEs registered to 5GS” or the attribute “maximum number of UEs with at least one PDU session/PDN connection”.

For example, the NSACF 77 may determine whether S-NSSAI #2 is associated with the attribute “UEs registered to 5GS” or the attribute “maximum number of UEs with at least one PDU session/PDN connection”. Then, the NSACF 77 may not check the count of the number of registered UEs 3 for S-NSSAI #2 in a case where the NSACF 77 determines that S-NSSAI #2 is associated with the attribute “maximum number of UEs with at least one PDU session/PDN connection”.

For example, the NSACF 77 may determine whether S-NSSAI #1 is associated with the attribute “UEs registered to 5GS” or the attribute “maximum number of UEs with at least one PDU session/PDN connection”. Then, the NSACF 77 may check the count of the number of registered UEs 3 for S-NSSAI #1 in a case where the NSACF 77 determines that S-NSSAI #1 is associated with the attribute “UEs registered to 5GS”.

Step 7: The NSACF 77 uses an Nnsacf_NSAC_NumOfUEsUpdate_Response service operation to inform to the AMF 70 of whether the limit of the maximum number of UEs registered per Network Slice has been reached or not for Network Slice(s) which is associated with the existing attribute. The NSACF 77 also sends to the AMF 70 the Unchecked NSSAI which includes the Network Slice(s) which is associated with the new attribute.

The Allowed NSSAI may include S-NSSAI #1. The Allowed NSSAI may also include S-NSSAI #2. The Allowed NSSAI may include at least one of S-NSSAI #1 and S-NSSAI #2. The Unchecked NSSAI may include S-NSSAI #2. The NSACF 77 may store the Unchecked NSSAI.

For example, the NSACF 77 may send an Nnsacf_NSAC_NumOfUEsUpdate_Response message including Allowed NSSAI which includes S-NSSAI #1 in a case where the maximum number of UEs registered for S-NSSAI #1 is not reached.

For example, the NSACF 77 may send the Nnsacf_NSAC_NumOfUEsUpdate_Response message including Rejected NSSAI which includes S-NSSAI #1 in a case where the maximum number of UEs registered for S-NSSAI #1 is reached.

For example, the NSACF 77 may send the Nnsacf_NSAC_NumOfUEsUpdate_Response message including information indicating that the maximum number of UEs registered for S-NSSAI #1 is not reached in a case where the maximum number of UEs registered for S-NSSAI #1 is not reached.

For example, the NSACF 77 may send the Nnsacf_NSAC_NumOfUEsUpdate_Response message including information indicating that the maximum number of UEs registered for S-NSSAI #1 is not reached in addition to or instead of sending the Allowed NSSAI including S-NSSAI #1.

For example, the NSACF 77 may send the Nnsacf_NSAC_NumOfUEsUpdate_Response message including information indicating that the maximum number of UEs registered for S-NSSAI #1 is reached in a case where the maximum number of UEs registered for S-NSSAI #1 is reached.

For example, the NSACF 77 may send the Nnsacf_NSAC_NumOfUEsUpdate_Response message including information indicating that the maximum number of UEs registered for S-NSSAI #1 is reached in addition to or instead of sending the Rejected NSSAI including S-NSSAI #1.

For example, the NSACF 77 may send the Nnsacf_NSAC_NumOfUEsUpdate_Response message including Unchecked NSSAI which includes S-NSSAI #2 in a case where the NSACF 77 does not check the count of the number of registered UEs 3 for S-NSSAI #2 based on the new attribute “maximum number of UEs with at least one PDU session/PDN connection” (or base on the determination described in step 6).

For example, the NSACF 77 may send the Nnsacf_NSAC_NumOfUEsUpdate_Response message including information indicating that checking the count of the number of registered UEs 3 for S-NSSAI #2 is not performed in addition to or instead of sending the Unchecked NSSAI.

Step 8: Upon reception of the response from the NSACF 77, the AMF 70 sends the Registration Accept message to the UE 3 including at least one of the Allowed NSSAI which indicates a set of S-NSSAIs the UE 3 can use to access services from the serving PLMN in the current Registration Area and the Rejected NSSAI which indicates a set of S-NSSAIs the UE 3 cannot use for accessing services. The Registration Accept message also include the Unchecked NSSAI which indicates a set of S-NSSAIs which are subject to NSAC and to be checked with the NSACF 77 during the PDU session establishment procedure before allowing the UE 3 to use them to access services from the serving PLMN. The Unchecked NSSAI may not be included in the Registration Accept message.

Unchecked NSSAI includes a set of S-NSSAIs with the attribute “maximum number of UEs with at least one PDU session/PDN connection” and its availability is not yet checked with the NSACF 77 during the Registration procedure as the PDU session to the UE 3 is not established. UEs can use S-NSSAI(s) specified in the Unchecked NSSAI while requesting PDU session establishment, but the availability of the S-NSSAI(s) will be known only at the end of the PDU session establishment procedure after checking with the NSACF. The AMF 70 may store the Unchecked NSSAI. When the UE 3 performs mobility registration procedure upon reselection of a cell of TAI not belonging to the registered TAI, the old AMF includes the Unchecked NSSAI in the message to the new AMF. The new AMF stores the Unchecked NSSAI and updates the number of UE count during the PDU session establishment procedure for the S-NSSAI stored in the Unchecked NSSAI.

Here, the Serving PLMN (e.g., the AMF 70) sends the Allowed NSSAI (including e.g., S-NSSAI #1) and the Unchecked NSSAI (including e.g., S-NSSAI #2) to the UE 3 in the Registration Accept message. The Allowed NSSAI may include S-NSSAI #1. The Allowed NSSAI may also include S-NSSAI #2. The Allowed NSSAI may include at least one of S-NSSAI #1 and S-NSSAI #2. The Unchecked NSSAI may include S-NSSAI #2.

For example, the AMF 70 may send the Registration Accept message including the Allowed NSSAI in a case where the AMF 70 receives the Allowed NSSAI from the NSACF 77.

For example, the AMF 70 may send the Registration Accept message including the Rejected NSSAI in a case where the AMF 70 receives the Rejected NSSAI from the NSACF 77.

For example, the AMF 70 may send the Registration Accept message including the Unchecked NSSAI in a case where the AMF 70 receives the Unchecked NSSAI from the NSACF 77.

For example, the AMF 70 may send the Registration Accept message including the Allowed NSSAI which includes S-NSSAI #1 in a case where the AMF 70 receives the Allowed NSSAI which includes S-NSSAI #1 from the NSACF 77.

For example, the AMF 70 may send the Registration Accept message including the Rejected NSSAI which includes S-NSSAI #1 in a case where the AMF 70 receives the Rejected NSSAI which includes S-NSSAI #1 from the NSACF 77.

For example, the AMF 70 may send the Registration Accept message including the Unchecked NSSAI which includes S-NSSAI #2 in a case where the AMF 70 receives the Unchecked NSSAI which includes S-NSSAI #2 from the NSACF 77.

For example, the AMF 70 may send the Registration Accept message including the Allowed NSSAI which includes S-NSSAI #1 and S-NSSAI #2 and the Unchecked NSSAI which includes S-NSSAI #2 in a case where the AMF 70 receives the Allowed NSSAI which includes S-NSSAI #1 and S-NSSAI #2 and the Unchecked NSSAI which includes S-NSSAI #2 from the NSACF 77.

For example, the AMF 70 may send the Registration Accept message including the Allowed NSSAI which includes S-NSSAI #1 in a case where the AMF 70 receives, from the NSACF 77, the information indicating that the maximum number of UEs registered for S-NSSAI #1 is not reached.

For example, the AMF 70 may send the Registration Accept message including the Rejected NSSAI which includes S-NSSAI #1 in a case where the AMF 70 receives, from the NSACF 77, the information indicating that the maximum number of UEs registered for S-NSSAI #1 is reached.

For example, the AMF 70 may send the Registration Accept message including the Unchecked NSSAI which includes S-NSSAI #2 in a case where the AMF 70 receives, from the NSACF 77, the information indicating that checking the count of the number of registered UEs 3 for S-NSSAI #2 is not performed.

For example, the AMF 70 may send the Registration Accept message including the Allowed NSSAI which includes S-NSSAI #1 and S-NSSAI #2 and the Unchecked NSSAI which includes S-NSSAI #2 in a case where the AMF 70 receives, from the NSACF 77, the information indicating that the maximum number of UEs registered for S-NSSAI #1 is not reached and the information indicating that checking the count of the number of registered UEs 3 for S-NSSAI #2 is not performed.

For example, the AMF 70 may send the Registration Accept message including the Rejected NSSAI which includes S-NSSAI #1 and the Allowed NSSAI which includes S-NSSAI #2 and the Unchecked NSSAI which includes S-NSSAI #2 in a case where the AMF 70 receives, from the NSACF 77, the information indicating that the maximum number of UEs registered for S-NSSAI #1 is reached and the information indicating that checking the count of the number of registered UEs 3 for S-NSSAI #2 is not performed.

For example, the AMF 70 may send the Registration Accept message including information indicating that the checking the count of the number of registered UEs 3 for S-NSSAI #2 is not performed in addition to or instead of sending the Unchecked NSSAI.

For example, the AMF 70 may send the Registration Accept message including information indicating that the checking the count of the number of registered UEs 3 for S-NSSAI #2 is not performed in a case where the AMF 70 receives, from the NSACF 77, the information indicating that checking the count of number of registered UEs 3 for S-NSSAI #2 is not performed.

### Variant 1 of First Example of the Second Aspect

In order to distinguish the Nnsacf_NSAC_NumOfUEsUpdate_Request message from the AMF 70 and the Nnsacf_NSAC_NumOfUEsUpdate_Request message from the SMF 71, the AMF 70 may include, in the Nnsacf_NSAC_NumOfUEsUpdate_Request message, information indicating that the Nnsacf_NSAC_NumOfUEsUpdate_Request message is sent from the AMF 70.

In a case where the NSACF 77 receives the information indicating that the Nnsacf_NSAC_NumOfUEsUpdate_Request message is sent from the AMF 70 and the NSACF 77 determines that S-NSSAI #2 is associated with the attribute “maximum number of UEs with at least one PDU session/PDN connection”, the NSACF 77 may not check the count of the number of registered UEs 3 for S-NSSAI #2.

For example, instead of the information indicating that the Nnsacf_NSAC_NumOfUEsUpdate_Request message is sent from the AMF 70, information indicating that the Nnsacf_NSAC_NumOfUEsUpdate_Request message is sent during the registration procedure may be used.

### Second Example of the Second Aspect

This example comprises a mechanism for performing the number of UEs per S-NSSAI availability check and update procedure by configuring NSACF to maintain the new attribute “maximum number of UEs with at least one PDU session/PDN connection” per Network Slice basis during the PDU session establishment procedure.

The detailed processes of the Second example of the Second Aspect are described below with reference to FIG. 4. FIG. 4 shows a procedure for configuring the NSACF to be aware of Network Slice(s) (S-NSSAI(s)) with the new attribute “maximum number of UEs with at least one PDU session/PDN connection” and applying NSAC during a PDU session establishment procedure. The processes of the Second example of the Second Aspect may be performed after the processes of the First example of each Aspect.

Step 1: An NSACF 77 is configured to be aware of Network Slice(s) (S-NSSAI(s)) with the new attribute “maximum number of UEs with at least one PDU session/PDN connection” configuration data for performing NSAC based on the Slice type and its attribute. This step 1 may be the same as the step 1 in FIG. 3.

Step 2: A UE 3 provides the S-NSSAI (e.g., S-NSSAI #2) and/or the Unchecked NSSAI (including e.g., S-NSSAI #2) to an SMF 71 as part of PDU session establishment request.

Step 2 can be separated into the following two parts.

The UE 3 may send a UL NAS Transport message to an AMF 70 including S-NSSAI (e.g., S-NSSAI #2), a Payload container and/or the Unchecked NSSAI (including e.g., S-NSSAI #2). The Payload container contains the PDU session establishment request message.

Upon reception of the UL NAS Transport message in the AMF 70, the AMF 70 may send an Nsmf_PDUSession_CreateSMContext Request message to the SMF 71 including the PDU session establishment request message and/or the Unchecked NSSAI (including e.g., S-NSSAI #2).

In one example, the PDU session establishment request message may include the Unchecked NSSAI (including e.g., S-NSSAI #2).

Optionally, if the Serving PLMN is not a UE 3's Home PLMN, the UE 3 may include a Mapping of the Allowed NSSAI/Unchecked NSSAI which is the mapping of each S-NSSAI of the Allowed NSSAI/Unchecked NSSAI to the HPLMN S-NSSAIs.

The Unchecked NSSAI may not be included in the PDU session establishment request message. For example, in a case where the UE 3 does not receive the Unchecked NSSAI from the AMF 70 in step 8 of FIG. 3, the UE 3 may not send the Unchecked NSSAI.

For example, in a case where the UE 3 receives the information indicating that checking the count of the number of registered UEs 3 for S-NSSAI #2 is not performed in step 8 of FIG. 3, the UE 3 may include the information in the PDU session establishment request message. This step 2 may be the same as the step 2 in FIG. 2.

Step 3: Step 2 to step 10b of the FIG. 4.3.2.2.1-1: PDU Session Establishment procedure in TS 23.502 (NPL3) take place.

Step 4: The SMF 71 is configured with the information that indicates which Network Slice is subject to NSAC. If the S-NSSAI(s) in the Allowed NSSAI and/or Unchecked NSSAI and/or in the PDU session establishment request message is subject to NSAC irrespective of their attribute parameter, then the SMF 71 performs the number of UEs per network slice availability check and update procedure.

For example, in a case where the SMF 71 receives the Unchecked NSSAI which includes S-NSSAI #2, the SMF 71 may perform the number of UEs per network slice availability check and update procedure for S-NSSAI #2.

For example, in a case where S-NSSAI #2 is subject to NSAC and the SMF 71 receives the PDU session establishment request message which includes S-NSSAI #2 and/or the Unchecked NSSAI which includes S-NSSAI #2, the SMF 71 may perform the number of UEs per network slice availability check and update procedure for S-NSSAI #2.

There may be multiple NSACFs 77 for different S-NSSAIs which are subject to NSAC and thus the SMF 71 triggers the number of UEs per network slice availability check and update request to multiple NSACFs 77.

Step 5: The SMF 71 uses an Nnsacf_NSAC_NumOfUEsUpdate_Request service operation to share the UE ID, the PDU session ID, the S-NSSAI(s) values, and Access Type information with the NSACF 77 to increase the number of UEs 3 registered with the same S-NSSAI(s).

For example, the SMF 71 may send an Nnsacf_NSAC_NumOfUEsUpdate_Request message including S-NSSAI #2 to the NSACF 77.

For example, the SMF 71 may send the Nnsacf_NSAC_NumOfUEsUpdate_Request message including at least one of S-NSSAI #1 and S-NSSAI #2 to the NSACF 77.

For example, the SMF 71 may send the Nnsacf_NSAC_NumOfUEsUpdate_Request message including the Unchecked NSSAI which includes S-NSSAI #2 (and/or the information indicating that the checking the count of the number of registered UEs for S-NSSAI #2 is not performed) to the NSACF 77.

For example, the SMF 71 may send the Nnsacf_NSAC_NumOfUEsUpdate_Request message including at least one of S-NSSAI #1 and S-NSSAI #2 and the Unchecked NSSAI which includes S-NSSAI #2 (and/or the information indicating that the checking the count of the number of registered UEs for S-NSSAI #2 is not performed) to the NSACF 77.

Step 6: With the available new attribute configuration data (e.g., the attribute for each S-NSSAI(s)), the NSACF 77 can identify (or determine) Network Slice(s) which is associated with the new attribute “maximum number of UEs with at least one PDU session” and consider them for NSAC as they do not have a PDU session. The NSACF 77 checks the count of the number of registered UEs per Network Slice which is associated with the new attribute, increases the count, and allows the UE 3 to use the same S-NSSAI if the count does not exceed a maximum limit. Step 6 may be triggered by the reception of the Nnsacf_NSAC_NumOfUEsUpdate_Request message from the SMF 71.

For example, in a case where the NSACF 77 receives the Nnsacf_NSAC_NumOfUEsUpdate_Request message including S-NSSAI #2 from the SMF 71, the NSACF 77 may determine whether S-NSSAI #2 is associated with the attribute “maximum number of UEs with at least one PDU session/PDN connection”.

For example, the NSACF 77 may check the count of the number of registered UEs 3 for S-NSSAI #2 in a case where the NSACF 77 determines that S-NSSAI #2 is associated with the attribute “maximum number of UEs with at least one PDU session/PDN connection”.

For example, in a case where the NSACF 77 receives the Nnsacf_NSAC_NumOfUEsUpdate_Request message including S-NSSAI #2 from the SMF 71 and the NSACF 77 determines that S-NSSAI #2 is associated with the attribute “maximum number of UEs with at least one PDU session/PDN connection”, the NSACF 77 may check the count of the number of registered UEs for S-NSSAI #2.

For example, the NSACF 77 may check the count of the number of registered UEs for S-NSSAI #2, and increase the count and allow the UE 3 to use S-NSSAI #2 in a case where the count does not exceed the maximum limit.

For example, the NSACF 77 may check the count of the number of registered UEs for S-NSSAI #2, and may not increase the count and may not allow the UE 3 to use S-NSSAI #2 in a case where the count exceeds the maximum limit.

For example, the NSACF 77 may determine whether S-NSSAI #2 is associated with the attribute “maximum number of UEs with at least one PDU session/PDN connection” in a case where the NSACF 77 receives the Nnsacf_NSAC_NumOfUEsUpdate_Request message including S-NSSAI #2 from the SMF 71. Then, the NSACF 77 may check the count of the number of registered UEs for S-NSSAI #2 in a case where the NSACF 77 determines that S-NSSAI #2 is associated with the attribute “maximum number of UEs with at least one PDU session/PDN connection”. Then, the NSACF 77 may increase the count and allow the UE 3 to use S-NSSAI #2 in a case where the count does not exceed the maximum limit, and may not increase the count and may not allow the UE 3 to use S-NSSAI #2 in a case where the count exceeds the maximum limit.

For example, the NSACF 77 may determine whether S-NSSAI #2 is associated with the attribute “maximum number of UEs with at least one PDU session/PDN connection” in a case where the NSACF 77 receives the Nnsacf_NSAC_NumOfUEsUpdate_Request message including S-NSSAI #2 and/or the Unchecked NSSAI including S-NSSAI #2 from the SMF 71. Then, the NSACF 77 may check the count of the number of registered UEs for S-NSSAI #2 in a case where the NSACF 77 determines that S-NSSAI #2 is associated with the attribute “maximum number of UEs with at least one PDU session/PDN connection”. Then, the NSACF 77 may increase the count and allow the UE 3 to use S-NSSAI #2 in a case where the count does not exceed the maximum limit, and may not increase the count and may not allow the UE 3 to use S-NSSAI #2 in a case where the count exceeds the maximum limit.

For example, the NSACF 77 may determine whether S-NSSAI #2 is associated with the attribute “maximum number of UEs with at least one PDU session/PDN connection” in a case where the NSACF 77 receives the Nnsacf_NSAC_NumOfUEsUpdate_Request message including S-NSSAI #2 and/or the information indicating that the checking the count of the number of registered UEs for S-NSSAI #2 is not performed from the SMF 71. Then, the NSACF 77 may check the count of number of registered UEs for S-NSSAI #2 in a case where the NSACF 77 determines that S-NSSAI #2 is associated with the attribute “maximum number of UEs with at least one PDU session/PDN connection”. Then, the NSACF 77 may increase the count and allow the UE 3 to use S-NSSAI #2 in a case where the count does not exceed the maximum limit, and may not increase the count and may not allow the UE 3 to use S-NSSAI #2 in a case where the count exceeds the maximum limit.

For example, the NSACF 77 may check the count of the number of registered UEs for S-NSSAI #2 in a case where the NSACF 77 receives the Nnsacf_NSAC_NumOfUEsUpdate_Request message including S-NSSAI #2 and/or the Unchecked NSSAI which includes S-NSSAI #2 from the SMF 71 and S-NSSAI #2 in the Nnsacf_NSAC_NumOfUEsUpdate_Request message and/or the Unchecked NSSAI is associated with the attribute “maximum number of UEs with at least one PDU session/PDN connection”. Then, the NSACF 77 may increase the count and allow the UE 3 to use S-NSSAI #2 in a case where the count does not exceed the maximum limit, and may not increase the count and may not allow the UE 3 to use S-NSSAI #2 in a case where the count exceeds the maximum limit.

For example, the NSACF 77 may check the count of the number of registered UEs for S-NSSAI #2 in a case where the NSACF 77 receives the Nnsacf_NSAC_NumOfUEsUpdate_Request message including S-NSSAI #2 and/or the information indicating that the checking the count of number of registered UEs for S-NSSAI #2 is not performed from the SMF 71 and S-NSSAI #2 in the Nnsacf_NSAC_NumOfUEsUpdate_Request message and/or S-NSSAI #2 indicated by the above information is associated with the attribute “maximum number of UEs with at least one PDU session/PDN connection”. Then, the NSACF 77 may increase the count and allow the UE 3 to use S-NSSAI #2 in a case where the count does not exceed the maximum limit, and may not increase the count and may not allow the UE 3 to use S-NSSAI #2 in a case where the count exceeds the maximum limit. This step 6 may be the same as the step 6a in FIG. 2.

Step 7: The NSACF 77 uses an Nnsacf_NSAC_NumOfUEsUpdate_Response service operation to inform to the SMF 71 of whether the limit of the maximum number of UEs registered per Network Slice has been reached or not.

For example, the NSACF 77 may send an Nnsacf_NSAC_NumOfUEsUpdate_Response message including information indicating that the maximum number of UEs registered for S-NSSAI #2 is not reached in a case where the maximum number of UEs registered for S-NSSAI #2 is not reached.

For example, the NSACF 77 may send the Nnsacf_NSAC_NumOfUEsUpdate_Response message including information indicating that the maximum number of UEs registered for S-NSSAI #2 is reached in a case where the maximum number of UEs registered for S-NSSAI #2 is reached.

As Network Slice(s) associated with the existing attribute has already been counted during the Registration procedure, the NSACF 77 sends them to the SMF 71 for direct processing without applying NSAC again.

For example, in a case where the number of UEs 3 for S-NSSAI #1 has been already counted in step 6 of FIG. 3 and the NSACF 77 receives the Nnsacf_NSAC_NumOfUEsUpdate_Request message including S-NSSAI #1, the NSACF 77 may not count the number of UEs 3 for S-NSSAI #1 and may send to the SMF 71 the Nnsacf_NSAC_NumOfUEsUpdate_Response message including information indicating that the maximum number of UEs registered for S-NSSAI #1 is not reached. Instead of the information indicating that the maximum number of UEs registered for S-NSSAI #1 is not reached, information indicating that the counting of the number of UEs 3 for S-NSSAI #1 has been already performed may be used.

Step 8: Upon reception of the response from the NSACF 77, the SMF 71 sends to the AMF 70 either the PDU Session Establishment Accept message by including an S-NSSAI from the Allowed NSSAI/Unchecked NSSAI received in step 3 or a PDU Session Establishment Reject message with a cause that “maximum number of UEs with at least one PDU session per S-NSSAI is reached”. This step 8 may be the same as the step 8a in FIG. 2.

Step 9: The AMF 70 sends the received message from the SMF 71 to the UE 3. Here, the AMF 70 sends the PDU Session Establishment Reject message including Rejected S-NSSAI (e.g., S-NSSAI #2) with the cause that “maximum number of UEs with at least one PDU session per S-NSSAI is reached” and optionally a back off timer. The AMF 70 may send the PDU Session Establishment Reject message including a back off timer (or a back off timer value) to the UE 3. This step 9 may be the same as the step 9a in FIG. 2.

Step 10: When the UE 3 receives the PDU Session Establishment Accept message in step 9, the UE 3 removes S-NSSAI #2 from the Unchecked NSSAI list (or the Unchecked NSSAI). When the UE 3 receives the PDU Session Establishment Reject message in step 9, the UE 3 may start a timer with the value set in the back off timer and the UE 3 doesn't initiate the PDU session establishment procedure for the S-NSSAI #2 till the timer expires. This step 10 may be performed after the step 9a in FIG. 2. In this case, the AMF 70 may send a back off timer (or a back off timer value) to the UE 3 in the step 9a. For example, the sending the back off timer and the corresponding process(es) by the UE 3 may be applied to other aspects.

### Variant 1 of Second Example of the Second Aspect

In the same manner as the Variant 4 of Second example of the First Aspect, during the procedure in FIG. 4, the SMF 71 may perform the Number of PDU Sessions per network slice availability check and update procedure.

### Variant 2 of Second Example of the Second Aspect

The SMF 71 may use an Nnsacf_NSAC_NumOfPDUsUpdate_Request service operation instead of using the Nnsacf_NSAC_NumOfUEsUpdate_Request service operation. For example, the SMF 71 may send an Nnsacf_NSAC_NumOfPDUsUpdate_Request message including S-NSSAI #2 and/or the Unchecked NSSAI which includes S-NSSAI #2 in step 5.

For example, in a case where the NSACF 77 stores the Unchecked NSSAI which includes S-NSSAI #2 (e.g., the NSACF 77 sends the Unchecked NSSAI in step 8 of FIG. 3 and stores the sent Unchecked NSSAI which includes S-NSSAI #2) and the NSACF 77 receives the Nnsacf_NSAC_NumOfPDUsUpdate_Request message including S-NSSAI #2 (and/or the Unchecked NSSAI which includes S-NSSAI #2), the NSACF 77 may determine whether S-NSSAI #2 is associated with the attribute “maximum number of UEs with at least one PDU session/PDN connection”. In a case where the NSACF 77 determines that S-NSSAI #2 is associated with the attribute “maximum number of UEs with at least one PDU session/PDN connection”, the NSACF 77 may perform the process(es) in step 6.

In addition, the NSACF 77 may perform the Number of PDU Sessions per network slice availability check and update procedure in a case where the NSACF 77 receives the Nnsacf_NSAC_NumOfPDUsUpdate_Request message including S-NSSAI #2.

For example, the NSACF 77 may check the count of the number of registered UEs 3 for S-NSSAI #2, and increase the count and allow the UE 3 to use S-NSSAI #2 in a case where the count does not exceed the maximum limit, then the NSACF 77 may check the count of number of PDU sessions established on S-NSSAI #2.

For example, the NSACF 77 may include, in an Nnsacf_NSAC_NumOfPDUsUpdate_Response message, information indicating whether the maximum number of UEs registered for S-NSSAI #2 is reached and information indicating whether the maximum number of PDU sessions established on S-NSSAI #2 is reached based on results of the checking the count for the number of registered UEs 3 and the count for the number of PDU sessions established on S-NSSAI(s).

For example, the NSACF 77 may send, to the SMF 71, the Nnsacf_NSAC_NumOfPDUsUpdate_Response message including at least one of the information indicating that the maximum number of UEs registered for S-NSSAI #2 is not reached and information indicating that the maximum number of PDU sessions established on S-NSSAI #2 is not reached in a case where the maximum number of UEs registered for S-NSSAI #2 is not reached and the maximum number of PDU sessions established on S-NSSAI #2 is not reached.

For example, the NSACF 77 may send, to the SMF 71, the Nnsacf_NSAC_NumOfPDUsUpdate_Response message including at least one of the information indicating that the maximum number of UEs registered for S-NSSAI #2 is reached and information indicating that the maximum number of PDU sessions established on S-NSSAI #2 is reached in a case where the maximum number of UEs registered for S-NSSAI #2 is reached and the maximum number of PDU sessions established on S-NSSAI #2 is reached.

For example, the NSACF 77 may send, to the SMF 71, the Nnsacf_NSAC_NumOfPDUsUpdate_Response message including at least one of the information indicating that the maximum number of UEs registered for S-NSSAI #2 is reached and information indicating that the maximum number of PDU sessions established on S-NSSAI #2 is not reached in a case where the maximum number of UEs registered for S-NSSAI #2 is reached and the maximum number of PDU sessions established on S-NSSAI #2 is not reached.

For example, the NSACF 77 may send, to the SMF 71, the Nnsacf_NSAC_NumOfPDUsUpdate_Response message including at least one of the information indicating that the maximum number of UEs registered for S-NSSAI #2 is not reached and information indicating that the maximum number of PDU sessions established on S-NSSAI #2 is reached in a case where the maximum number of UEs registered for S-NSSAI #2 is not reached and the maximum number of PDU sessions established on S-NSSAI #2 is reached.

For example, the SMF 71 may send the PDU Session Establishment Accept message including S-NSSAI #2 in a case where the response from the NSACF 77 includes the information indicating that the maximum number of UEs registered for S-NSSAI #2 is not reached and the information indicating that the maximum number of PDU sessions established on S-NSSAI #2 is not reached.

For example, the SMF 71 may send the PDU Session Establishment Reject message including S-NSSAI #2 in a case where the response from the NSACF 77 includes at least one of the information indicating that the maximum number of UEs registered for S-NSSAI #2 is reached and the information indicating that the maximum number of PDU sessions established on S-NSSAI #2 is reached.

### Variant 3 of Second Example of the Second Aspect

Variant 5 of Second example of the First Aspect may be applied to the Second Aspect.

### Variant 4 of Second Example of the Second Aspect

Variant 6 of Second example of the First Aspect may be applied to the Second Aspect.

For example, in a case where the NSACF 77 receives the information indicating that the Nnsacf_NSAC_NumOfUEsUpdate_Request message is sent from the SMF 71 and the NSACF 77 determines that S-NSSAI #2 is associated with the attribute “maximum number of UEs with at least one PDU session/PDN connection”, the NSACF 77 may check the count of the number of registered UEs 3 for S-NSSAI #2.

### Third Aspect

This aspect comprises a mechanism to support the GSMA defined new attribute “maximum number of UEs with at least one PDU session/PDN connection” per Network Slice by configuring the NSACF internally to be aware of the Network Slice(s) with its attribute details for monitoring and limiting the UEs count in a uniform manner.

For example, this aspect comprises a mechanism to support the GSMA defined new attribute “maximum number of UEs with at least one PDU session/PDN connection” per Network Slice which can be used by the maximum number of UEs (both 5GS and EPS UEs) simultaneously by configuring the NSACF internally to be aware of the Network Slice(s) with its attribute details for monitoring and limiting the UEs count in a uniform manner.

### First Example of the Third Aspect

This example comprises a mechanism in which the NSACF is configured internally to be aware of the Network Slice(s) and its attribute details for performing the number of UEs per S-NSSAI availability check and update procedure within the NSACF during the Registration procedure.

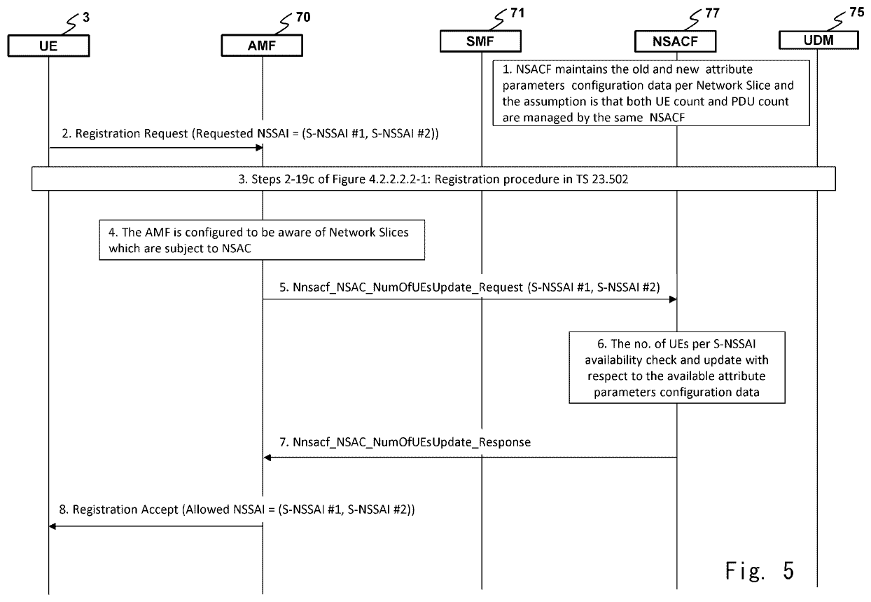

The detailed processes of the First example of the Third Aspect are described below with reference to FIG. 5. FIG. 5 shows a procedure for configuring the NSACF internally to be aware of Network Slice(s) (S-NSSAI(s)) with its attributes configuration data and applying NSAC during a Registration procedure.

Step 1: An NSACF 77 is configured internally to be aware of Network Slice(s) (S-NSSAI(s)) with its attribute parameters configuration data for performing NSAC based on the Slice type and its attribute. This step 1 may be the same as the step 1 in FIG. 3.

For the case of Network Slice(s) with the attribute “maximum number of UEs with at least one PDU session/PDN connection”, a UE 3 registered in a 5GS Network Slice with no PDU session established is not counted. Also, the new attribute “maximum number of UEs with at least one PDU session/PDN connection” is not used together with the attribute “maximum number of UEs”.

Step 2: An NSSAI is a collection of S-NSSAIs. Requested NSSAI is an NSSAI provided by the UE 3 to the Serving PLMN during a registration procedure. Here, the UE 3 provides a Requested NSSAI to an AMF 70 as part of the Registration Request and the Requested NSSAI includes two S-NSSAIs (S-NSSAI #1 and S-NSSAI #2). This step 2 may be the same as the step 2 in FIG. 1.

Optionally, if the Serving PLMN is not a UE 3's Home PLMN, then the UE 3 may include s Mapping of Requested NSSAI which is the mapping of each S-NSSAI of the Requested NSSAI to the HPLMN S-NSSAIs.

Step 3: Step 2 to step 19c of the FIG. 4.2.2.2.2-1: Registration procedure in TS 23.502 (NPL3) take place.

Step 4: The AMF 70 is configured with the information that indicates which Network Slice is subject to NSAC. If an S-NSSAI(s) in the Requested NSSAI is subject to NSAC irrespective of their attribute parameter, then the AMF 70 performs the number of UEs per network slice availability check and update procedure. This step 4 may be the same as the step 4 in FIG. 3.

There may be multiple NSACFs 77 for different S-NSSAIs which are subject to NSAC and thus the AMF 70 triggers the number of UEs 3 per network slice availability check and update request to multiple NSACFs 77.

Step 5: The AMF 70 uses an Nnsacf_NSAC_NumOfUEsUpdate_Request service operation to share the UE ID, the S-NSSAI(s) values, and Access Type information with the NSACF 77 to increase the number of UEs 3 registered with the same S-NSSAI(s).

This step 5 may be the same as the step 5 in FIG. 3.

Step 6: With the available attribute parameters configuration data, the NSACF 77 can identify Network Slice(s) and group them based on the attribute parameters such as Network Slice(s) which is associated with i) the new attribute “maximum number of UEs with at least one PDU session/PDN connection” and ii) the existing attribute “UEs registered to 5GS”.

Network Slice(s) which is associated with the existing attribute “UEs registered to 5GS” are considered for NSAC at this stage. The NSACF 77 checks the count of the number of registered UEs 3 per Network Slice which is associated with the existing attribute, increases the count, and allows the UE 3 to use the same S-NSSAI if the count does not exceed a maximum limit.

For the Network Slice(s) which is associated with the new attribute “maximum number of UEs with at least one PDU session/PDN connection” during the registration procedure, the NSACF 77 does not perform any action for the Network Slice(s) and simply may include the Network Slice(s) in the Allowed NSSAI passively. This step 6 may be the same as the step 6 in FIG. 3.

Step 7: The NSACF 77 uses an Nnsacf_NSAC_NumOfUEsUpdate_Response service operation to inform to the AMF 70 of whether the limit of the maximum number of UEs registered per Network Slice has been reached or not for Network Slice(s) which is associated with the existing attribute.

This step 7 may be the same as the step 7 in FIG. 3. Alternatively, this step 7 may be the same as the step 7 in FIG. 3, except for sending the Unchecked NSSAI.

For example, the NSACF 77 may send the Nnsacf_NSAC_NumOfUEsUpdate_Response message including Allowed NSSAI which includes S-NSSAI #1 in a case where the maximum number of UEs registered for S-NSSAI #1 is not reached.

For example, the NSACF 77 may send the Nnsacf_NSAC_NumOfUEsUpdate_Response message including Rejected NSSAI which includes S-NSSAI #1 in a case where the maximum number of UEs registered for S-NSSAI #1 is reached.

For example, the NSACF 77 may send the Nnsacf_NSAC_NumOfUEsUpdate_Response message including information indicating that the maximum number of UEs registered for S-NSSAI #1 is not reached in a case where the maximum number of UEs registered for S-NSSAI #1 is not reached.

For example, the NSACF 77 may send the Nnsacf_NSAC_NumOfUEsUpdate_Response message including information indicating that the maximum number of UEs registered for S-NSSAI #1 is not reached in addition to or instead of sending the Allowed NSSAI including S-NSSAI #1.

For example, the NSACF 77 may send the Nnsacf_NSAC_NumOfUEsUpdate_Response message including information indicating that the maximum number of UEs registered for S-NSSAI #1 is reached in a case where the maximum number of UEs registered for S-NSSAI #1 is reached.

For example, the NSACF 77 may send the Nnsacf_NSAC_NumOfUEsUpdate_Response message including information indicating that the maximum number of UEs registered for S-NSSAI #1 is reached in addition to or instead of sending the Rejected NSSAI including S-NSSAI #1.

For example, the NSACF 77 may send the Nnsacf_NSAC_NumOfUEsUpdate_Response message including Allowed NSSAI which includes S-NSSAI #2 in a case where the NSACF 77 does not check the count of the number of registered UEs 3 for S-NSSAI #2 based on the new attribute “maximum number of UEs with at least one PDU session/PDN connection” (e.g., even if the NSACF 77 does not perform the counting of number of registered UEs 3 for S-NSSAI #2).

For example, the NSACF 77 may send the Nnsacf_NSAC_NumOfUEsUpdate_Response message including information indicating that the maximum number of UEs registered for S-NSSAI #2 is not reached in a case where the NSACF 77 does not check the count of the number of registered UEs 3 for S-NSSAI #2 based on the new attribute “maximum number of UEs with at least one PDU session/PDN connection” (e.g., even if the NSACF 77 does not perform the counting of number of registered UEs 3 for S-NSSAI #2), in addition to or instead of sending the Allowed NSSAI including S-NSSAI #2.

The information indicating that the maximum number of UEs registered for S-NSSAI #2 is not reached may be expressed as information indicating that the counting of the number of UEs 3 for S-NSSAI #2 is not performed or information indicating that NSAC related to the number of UEs 3 for S-NSSAI #2 is not performed in this disclosure.

The Allowed NSSAI may include S-NSSAI #1. The Allowed NSSAI may also include S-NSSAI #2. The Allowed NSSAI may include at least one of S-NSSAI #1 and S-NSSAI #2.

Step 8: Upon reception of the response from the NSACF 77, the AMF 70 sends at least one of the Allowed NSSAI which indicates a set of S-NSSAIs the UE 3 can use to access services from the serving PLMN in the current Registration Area and the Rejected NSSAI which indicates a set of S-NSSAIs the UE 3 cannot use for accessing services. Here, the Serving PLMN AMF 70 sends the Allowed NSSAI (including e.g., S-NSSAI #1, S-NSSAI #2) to the UE 3 in the Registration Accept message.

This step 8 may be the same as the step 8 in FIG. 3. Alternatively, this step 8 may be the same as the step 8 in FIG. 3, except for sending the Unchecked NSSAI.

For example, the AMF 70 may send the Registration Accept message including the Allowed NSSAI in a case where the AMF 70 receives the Allowed NSSAI from the NSACF 77.

For example, the AMF 70 may send the Registration Accept message including the Rejected NSSAI in a case where the AMF 70 receives the Rejected NSSAI from the NSACF 77.

For example, the AMF 70 may send the Registration Accept message including the Allowed NSSAI which includes at least one of S-NSSAI #1 and S-NSSAI #2 in a case where the AMF 70 receives the Allowed NSSAI which includes at least one of S-NSSAI #1 and S-NSSAI #2 from the NSACF 77.

For example, the AMF 70 may send the Registration Accept message including the Rejected NSSAI which includes S-NSSAI #1 in a case where the AMF 70 receives the Rejected NSSAI which includes S-NSSAI #1 from the NSACF 77.

For example, the AMF 70 may send the Registration Accept message including the Allowed NSSAI which includes S-NSSAI #1 in a case where the AMF 70 receives, from the NSACF 77, the information indicating that the maximum number of UEs registered for S-NSSAI #1 is not reached.

For example, the AMF 70 may send the Registration Accept message including the Rejected NSSAI which includes S-NSSAI #1 in a case where the AMF 70 receives, from the NSACF 77, the information indicating that the maximum number of UEs registered for S-NSSAI #1 is reached.

For example, the AMF 70 may send the Registration Accept message including the Allowed NSSAI which includes at least one of S-NSSAI #1 and S-NSSAI #2 in a case where the AMF 70 receives, from the NSACF 77, the information indicating that the maximum number of UEs registered for S-NSSAI #1 is not reached and the information indicating that the maximum number of UEs registered for S-NSSAI #2 is not reached.

For example, the AMF 70 may send the Registration Accept message including the Rejected NSSAI which includes S-NSSAI #1 and the Allowed NSSAI which includes S-NSSAI #2 in a case where the AMF 70 receives, from the NSACF 77, the information indicating that the maximum number of UEs registered for S-NSSAI #1 is reached and the information indicating that the maximum number of UEs registered for S-NSSAI #2 is not reached.

### Variant 1 of First Example of the Third Aspect

Variant 1 of First example of the Second Aspect may be applied to the Third Aspect.

### Second Example of the Third Aspect

This example comprises a mechanism in which the NSACF is configured internally to be aware of the Network Slice(s) and its attribute details for performing the number of UEs per S-NSSAI availability check and update procedure within the NSACF during the PDU session establishment procedure.

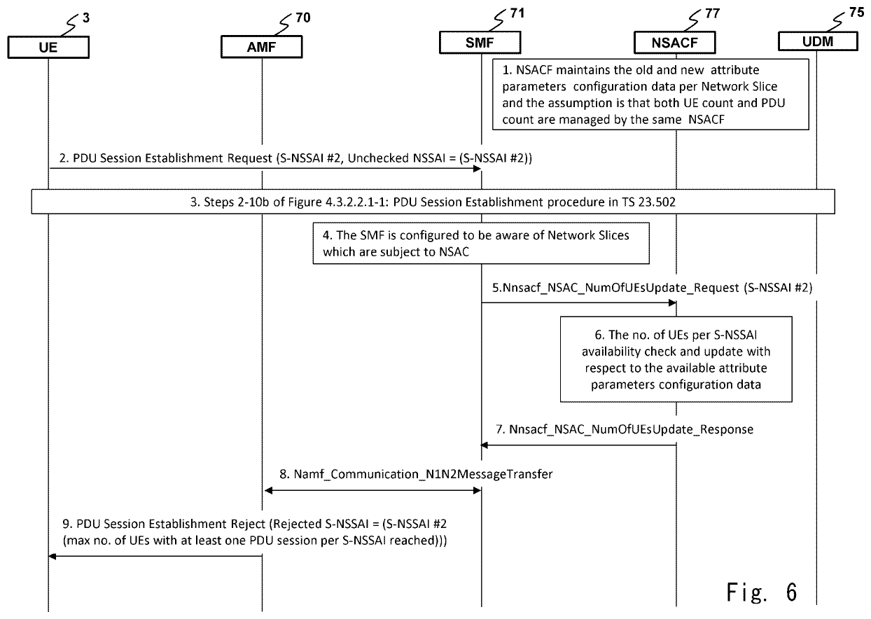

The detailed processes of the Second example of the Third Aspect are described below with reference to FIG. 6. FIG. 6 shows a procedure for configuring the NSACF internally to be aware of Network Slice(s) (S-NSSAI(s)) with its attribute parameters and applying NSAC during a PDU session establishment procedure. The processes of the Second example of the Third Aspect may be performed after the processes of the First example of the Aspect.

Step 1: An NSACF 77 is configured internally to be aware of Network Slice(s) with its attribute parameters configuration data for performing NSAC based on the Slice type and its attribute. This step 1 may be the same as the step 1 in FIG. 5.

Step 2: A UE 3 provides S-NSSAI (e.g., S-NSSAI #2) to an SMF 71 as part of PDU session establishment request.

Step 2 can be separated into the following two parts.

The UE 3 may send a UL NAS Transport message to an AMF 70 including S-NSSAI (e.g., S-NSSAI #2), a Payload container and/or the Unchecked NSSAI (e.g., S-NSSAI #2). The Payload container contains the PDU session establishment request message. The UL NAS Transport message may include the Unchecked NSSAI (including e.g., S-NSSAI #2).

Upon reception of the UL NAS Transport message in the AMF 70, the AMF 70 may send an Nsmf_PDUSession_CreateSMContext Request message to the SMF 71 including the PDU session establishment request message. The Nsmf_PDUSession_CreateSMContext Request message may include the Unchecked NSSAI (including e.g., S-NSSAI #2).

In one example, the PDU session establishment request message may include the Unchecked NSSAI (including e.g., S-NSSAI #2).

For example, in a case where the UE 3 has the Unchecked NSSAI (including e.g., S-NSSAI #2), the UE 3 may send the UL NAS Transport message including the Unchecked NSSAI to the AMF 70. For example, in a case where the UE 3 receives the Registration Accept message including the Unchecked NSSAI (including e.g., S-NSSAI #2) in step 8a of FIG. 1 or in step 8 of FIG. 3 and the UE 3 has the Unchecked NSSAI, the UE 3 may send the UL NAS Transport message including the Unchecked NSSAI.

Optionally, if the Serving PLMN is not a UE 3's Home PLMN, the UE 3 may include a Mapping of the Allowed NSSAI/Unchecked NSSAI which is the mapping of each S-NSSAI of the Allowed NSSAI/Unchecked NSSAI to the HPLMN S-NSSAIs.

Step 3: Step 2 to step 10b of the FIG. 4.3.2.2.1-1: PDU Session Establishment procedure in TS 23.502 (NPL3) take place.

Step 4: The SMF 71 is configured with the information that indicates which Network Slice is subject to NSAC. If the S-NSSAI(s) in the Allowed NSSAI is subject to NSAC irrespective of their attribute parameter, then the SMF 71 performs the number of UEs per network slice availability check and update procedure.

There may be multiple NSACFs 77 for different S-NSSAIs which are subject to NSAC and thus the SMF 71 triggers the number of UEs 3 per network slice availability check and update request to multiple NSACFs 77. This step 4 may be the same as the step 4 in FIG. 4.

Step 5: The SMF 71 uses an Nnsacf_NSAC_NumOfUEsUpdate_Request service operation to share the UE ID, the PDU session ID, the S-NSSAI(s) values, and Access Type information to the NSACF 77 to increase the number of UEs 3 registered with the same S-NSSAI(s).

For example, the SMF 71 may send an Nnsacf_NSAC_NumOfUEsUpdate_Request message including S-NSSAI #2 to the NSACF 77.

For example, the SMF 71 may send the Nnsacf_NSAC_NumOfUEsUpdate_Request message including at least one of S-NSSAI #1 and S-NSSAI #2 to the NSACF 77.

For example, the SMF 71 may send the Nnsacf_NSAC_NumOfUEsUpdate_Request message including the Unchecked NSSAI which includes S-NSSAI #2 to the NSACF 77. This step 5 may be the same as the step 5 in FIG. 4.

Step 6: With the available new attribute configuration data (e.g., the attribute for each S-NSSAI(s)), the NSACF 77 can identify Network Slice(s) which are associated with the new attribute “maximum number of UEs with at least one PDU session/PDN connection” and consider them for NSAC as they do not have a PDU session. The NSACF 77 checks the count of the number of registered UEs 3 per Network Slice which is associated with the new attribute, increases the count, and allows the UE 3 to use the same S-NSSAI if the count does not exceed a maximum limit. This step 6 may be triggered by the reception of the Nnsacf_NSAC_NumOfUEsUpdate_Request message from the SMF 71. This step 6 may be the same as the step 6 in FIG. 4.

Step 7: The NSACF 77 uses an Nnsacf_NSAC_NumOfUEsUpdate_Response service operation to inform to the SMF 71 of whether the limit of the maximum number of UEs 3 registered per Network Slice has been reached or not. This step 7 may be the same as the step 7 in FIG. 4.

As Network Slice(s) associated with the existing attribute have already been counted during the Registration procedure, the NSACF 77 may send them to the SMF 71 for direct processing without applying NSAC again.

For example, in a case where the number of UEs 3 for S-NSSAI #1 has been already counted in step 6 of FIG. 3 and the NSACF 77 receives the Nnsacf_NSAC_NumOfUEsUpdate_Request message including S-NSSAI #1, the NSACF 77 may not count the number of UEs 3 for S-NSSAI #1 and may send to the SMF 71 the Nnsacf_NSAC_NumOfUEsUpdate_Response message including information indicating that the maximum number of UEs registered for S-NSSAI #1 is not reached.

Step 8: Upon reception of the response from the NSACF 77, the SMF 71 sends to the AMF 70 either a PDU Session Establishment Accept message by including an S-NSSAI from the Allowed NSSAI received in step 3 or a PDU Session Establishment Reject message with a cause that “maximum number of UEs with at least one PDU session per S-NSSAI is reached”. This step 8 may be the same as the step 8 in FIG. 4.

Step 9: The AMF 70 sends the received message from the SMF 71 to the UE 3. Here, the AMF 70 sends the PDU Session Establishment Reject message with the cause that “maximum number of UEs with at least one PDU session per S-NSSAI is reached”. This step 9 may be the same as the step 9 in FIG. 4.

The AMF 70 may send the PDU Session Establishment Reject message including a back off timer (or a back off timer value) to the UE 3. The UE 3 may perform same process(es) in step 10 of FIG. 4 in a case where the UE 3 receives the back off timer.

### Variant 1 of Second Example of the Third Aspect

In the same manner as the Variant 4 of Second example of the First Aspect, during the procedure in FIG. 6, the SMF 71 may perform the Number of PDU Sessions per network slice availability check and update procedure.

### Variant 2 of Second Example of the Third Aspect

Variant 2 of Second example of the Second Aspect may be applied to the Third Aspect.

### Variant 3 of Second Example of the Third Aspect

Variant 5 of Second example of the First Aspect may be applied to the Third Aspect.

### Variant 4 of Second Example of the Third Aspect

Variant 6 of Second example of the First Aspect may be applied to the Third Aspect.

For example, in a case where the NSACF 77 receives the information indicating that the Nnsacf_NSAC_NumOfUEsUpdate_Request message is sent from the SMF 71 and the NSACF 77 determines that S-NSSAI #2 is associated with the attribute “maximum number of UEs with at least one PDU session/PDN connection”, the NSACF 77 may check the count of the number of registered UEs 3 for S-NSSAI #2.

### Fourth Aspect

This aspect comprises a mechanism for configuring the Early Admission Control (EAC) update procedure to activate the EAC mode for an S-NSSAI with the attribute “maximum number of UEs with at least one PDU session/PDN connection” which is subject to NSAC.

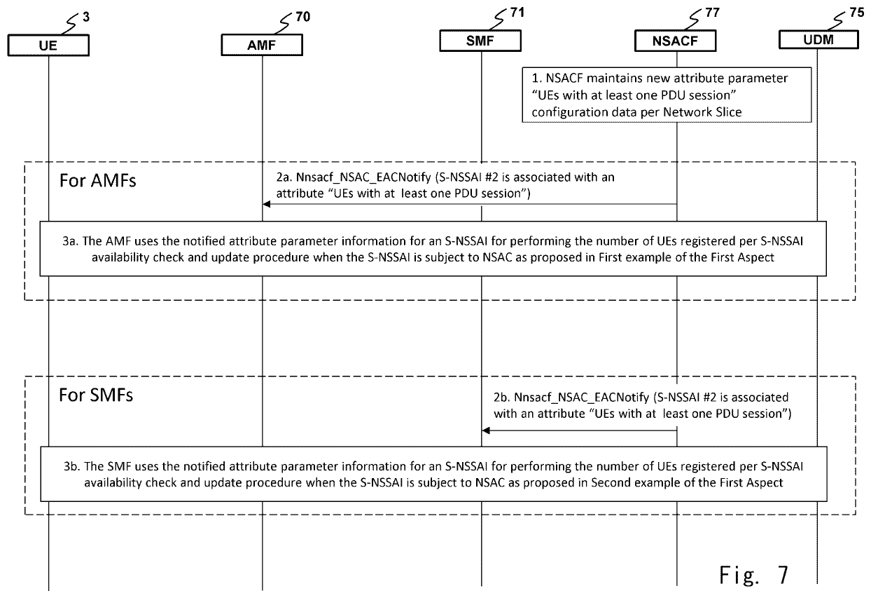

The detailed processes of the Fourth Aspect are described below with reference to FIG. 7. FIG. 7 shows an Early Admission Control (EAC) update procedure for an S-NSSAI with the attribute “maximum number of UEs with at least one PDU session/PDN connection” which is subject to NSAC.

Step 1: An NSACF 77 is configured to be aware of Network Slice(s) (S-NSSAI(s)) with the new attribute “maximum number of UEs with at least one PDU session/PDN connection” configuration data for performing NSAC based on the Slice type and its attribute. This step 1 may be the same as the step 1 in FIG. 3.

An AMF 70 may subscribe to the EAC notification.

For example, the AMF 70 may subscribe to the EAC notification for the S-NSSAI in a case where the AMF 70 performs the number of UEs per network slice availability check and update procedure for the S-NSSAI with the NSACF 77.

For example, the AMF 70 implicitly subscribes to an EAC notification for the S-NSSAI when it performs the number of UEs per network slice availability check and update procedure for the S-NSSAI with the NSACF 77.

### (For AMFs)

Step 2a: The NSACF 77 sends the EAC mode notification to the AMF 70 along with the attribute parameter with which the subscribed S-NSSAI is associated.

For example, the NSACF 77 may send, to the AMF 70, the EAC mode notification (e.g., an Nnsacf_NSAC_EACNotify message) including information which indicates that S-NSSAI #2 has or is associated with the attribute “maximum number of UEs with at least one PDU session/PDN connection”. The EAC mode notification may include information which indicates that S-NSSAI #1 has or is associated with the attribute “UEs registered to 5GS”.

In this disclosure, the attribute parameter may include at least one of the information which indicates that S-NSSAI #2 has or is associated with the attribute “maximum number of UEs with at least one PDU session/PDN connection” and the information which indicates that S-NSSAI #1 has or is associated with the attribute “UEs registered to 5GS”.

Step 3a: The AMF 70 uses the notified attribute parameter information for S-NSSAI for performing the number of UEs per S-NSSAI availability check and update procedure when the S-NSSAI is subject to NSAC and associated with the attribute “maximum number of UEs with at least one PDU session/PDN connection” as proposed in the First example of the First Aspect in FIG. 1.

### (For SMFs)

Step 2b: The NSACF 77 sends the EAC mode notification to the SMF 71 along with the attribute parameter with which the subscribed S-NSSAI is associated. For example, the NSACF 77 may send, to the SMF 71, the EAC mode notification (e.g., an Nnsacf_NSAC_EACNotify message) including information which indicates that S-NSSAI #2 has or is associated with the attribute “maximum number of UEs with at least one PDU session/PDN connection”. The EAC mode notification may include information which indicates that S-NSSAI #1 has or is associated with the attribute “UEs registered to 5GS”.

Step 3b: The SMF 71 uses the notified attribute parameter information for an S-NSSAI for performing the number of UEs per S-NSSAI availability check and update procedure when the S-NSSAI is subject to NSAC and associated with the attribute “maximum number of UEs with at least one PDU session/PDN connection” as proposed in the Second example of the First Aspect in FIG. 2.

According to the above examples of the Aspects and their variants, it can solve at least the above-mentioned problem.

For example, the above examples of the Aspects and their variants provide at least one of an apparatus and a method which can solve at least the above-mentioned problem.

For example, the above examples of the Aspects and their variants can solve the problem that there is no mechanism to support at least one of the new attribute and the requirement in the current 3GPP specifications.

### (System Overview)

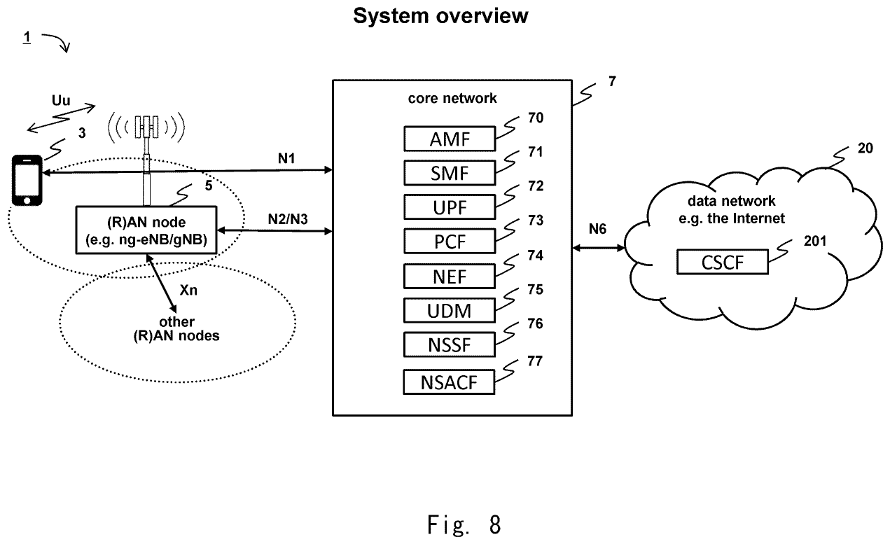

FIG. 8 schematically illustrates a telecommunication system 1 for a mobile (cellular or wireless) device (known as a user equipment (UE)) to which the above aspects are applicable.

The telecommunication system 1 represents a system overview in which an end-to-end communication is possible. For example, the UE 3 (or user equipment, ‘mobile device’ 3) communicates with other UEs 3 or service servers in the data network 20 via respective (R)AN nodes 5 and a core network 7.

The (R)AN node 5 supports any suitable radio access technology including, for example, a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may be split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU, and O-CU respectively.

The (R)AN node 5 may be split into one or more control plane functions and one or more user plane functions. Further, multiple user plane functions can be allocated to support a communication. In some aspects, user traffic may be distributed to multiple user plane functions and user traffic over each user plane function is aggregated in both the UE 3 and the (R)AN node 5. This split architecture may be called ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e., radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, a Network Slice Selection Function (NSSF) 76, and a Network Slice Admission Control Function (NSACF) 77. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighbouring (R)AN nodes 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPV4, IPV6, IPv4v6, Ethernet or unstructured data type.

The “Uu” interface may include a Control plane and User plane.

The User plane of the Uu interface is responsible for conveying user traffic between the UE 3 and a serving (R)AN node 5. The User plane of the Uu interface may have a layered structure with SDAP, PDCP, RLC and MAC sublayer over the physical connection.

The Control plane of the Uu interface is responsible for establishing, modifying, and releasing a connection between the UE 3 and a serving (R)AN node 5. The Control plane of the Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by embodiments in this disclosure, any of the following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by embodiments in this disclosure, any of the following parameters may be included together in the RRC Setup message.
   masterCellGroup and radioBearerConfig
RRC Setup Complete message: This message is sent from the UE 3 to the (R)AN node 5. In addition to the parameters that are disclosed by embodiments in this disclosure, any of the following parameters may be included together in the RRC Setup Complete message.
   guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible for providing a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by embodiments in this disclosure, any of the following parameters may be included together in the Registration Request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by embodiments in this disclosure, any of the following parameters may be included together in the Registration Accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by embodiments in this disclosure, the following parameter may be included together in the Registration Complete message.
SOR transparent container.
Authentication Request message: This message is sent from the AMF 70 to the UE 3. In addition to the parameters that are disclosed by embodiments in this disclosure, any of the following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by embodiments in this disclosure, any of the following parameters may be populated together in the Authentication Response message.
Authentication response message identity, Authentication response parameter and EAP message.
Authentication Result message: This message is sent from the AMF 70 to the UE 3. In addition to the parameters that are disclosed by embodiments in this disclosure, any of the following parameters may be populated together in the Authentication Result message.
ngKSI, EAP message and ABBA.
Authentication Failure message: This message is sent from the UE 3 to the AMF 70. In addition to the parameters that are disclosed by embodiments in this disclosure, any of the following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by embodiments in this disclosure, the following parameter may be populated together in the Authentication Reject message.
EAP message.
Service Request message: This message is sent from the UE 3 to the AMF 70. In addition to the parameters that are disclosed by embodiments in this disclosure, any of the following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by embodiments in this disclosure, any of the following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by embodiments in this disclosure, any of the following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by embodiments in this disclosure, any of the following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by embodiments in this disclosure, the following parameter may be populated together in the
Configuration Update Complete message. #Configuration update complete message identity.

### (User Equipment (UE))

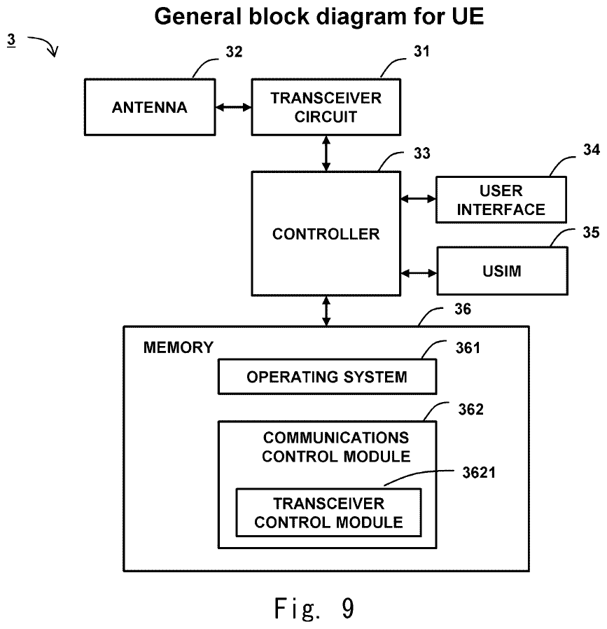

FIG. 9 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the FIG. 9, the UE 3 may have all the usual functionality of a conventional mobile device and this may be provided by any one or any combination of hardware, software, and firmware, as appropriate. Software may be pre-installed in the memory and/or may be downloaded via the telecommunication network or from a removable data storage device (e.g., a removable memory device (RMD)), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g., a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g., smart glasses, a smart watch, a smart ring, or a hearable device).

The UE 3 may be a car, or a connected car, or an autonomous car, or a vehicle device, or a motorcycle or V2X (Vehicle to Everything) communication module (e.g., Vehicle to Vehicle communication module, Vehicle to Infrastructure communication module, Vehicle to People communication module and Vehicle to Network communication module).

### ((R)AN Node)

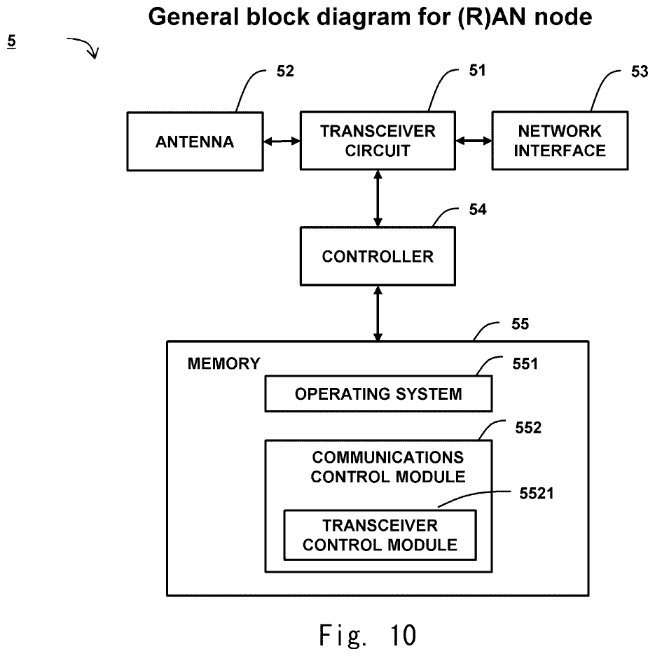

FIG. 10 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (e.g., an RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g., directly or indirectly). The signalling may include, for example, appropriately formatted signalling messages relating to a radio connection and a connection with the core network 7 (for a particular UE 3), and in particular, relating to connection establishment and maintenance (e.g., RRC connection establishment and other RRC messages), NG Application Protocol (NGAP) messages (i.e., messages by N2 reference point) and Xn application protocol (XnAP) messages (i.e., messages by Xn reference point), etc. Such signalling may also include, for example, broadcast information (e.g., Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

### (System Overview of (R)AN Node 5 Based on O-RAN Architecture)

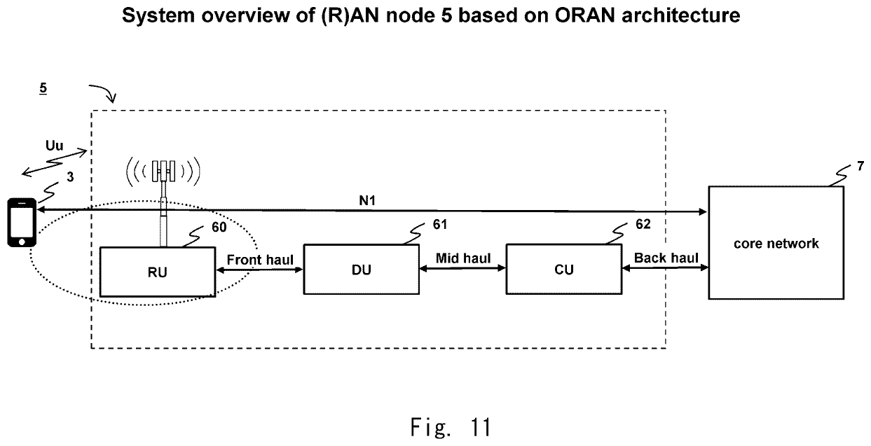

FIG. 11 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g., one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionality to communicate with a UE 3 over air interface, the DU 61 may provide functionalities to support MAC layer and RLC layer, the CU 62 may provide functionalities to support PDCP layer, SDAP layer and RRC layer.

### (Radio Unit (RU))

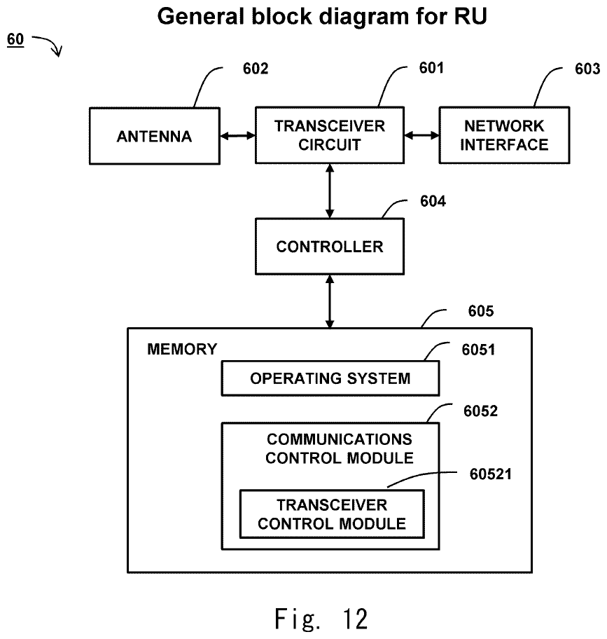

FIG. 12 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (e.g., a removable memory device (RMD)), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g., directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### (Distributed Unit (DU))

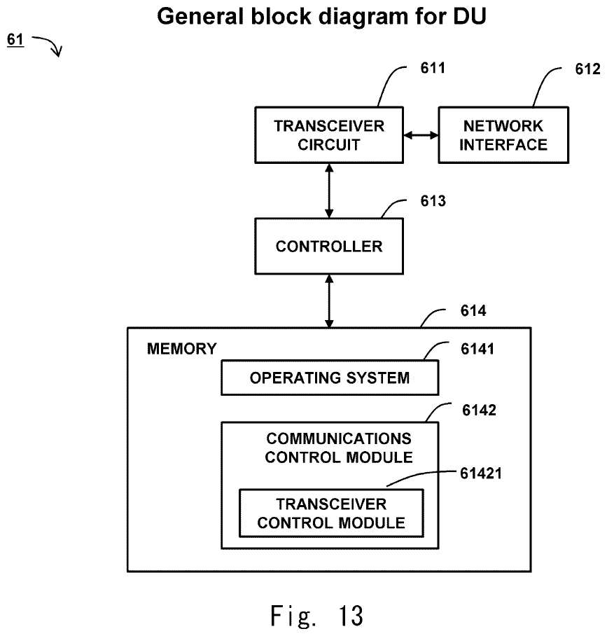

FIG. 13 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (e.g., a removable memory device (RMD)), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the DU 61 can be integrated/combined with the RU 60 or CU 62 as an integrated/combined unit. Any functionality in the description for DU 61 can be implemented in one of the integrated/combined unit above.

### (Centralized Unit (CU))

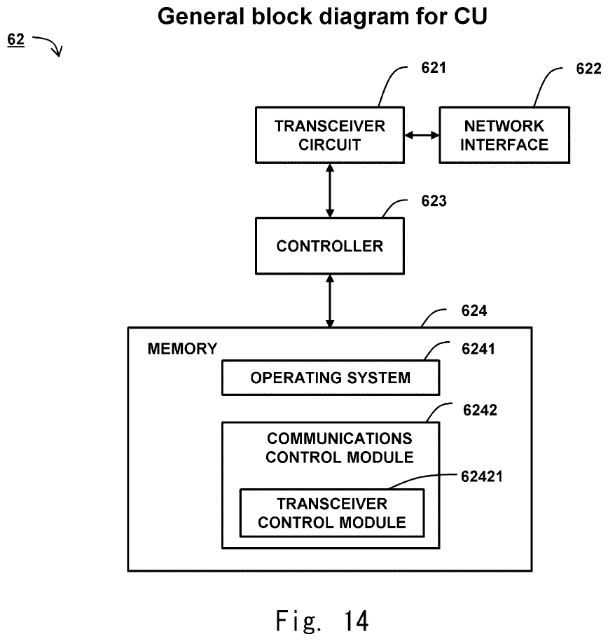

FIG. 14 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (e.g., a removable memory device (RMD)), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### (AMF)

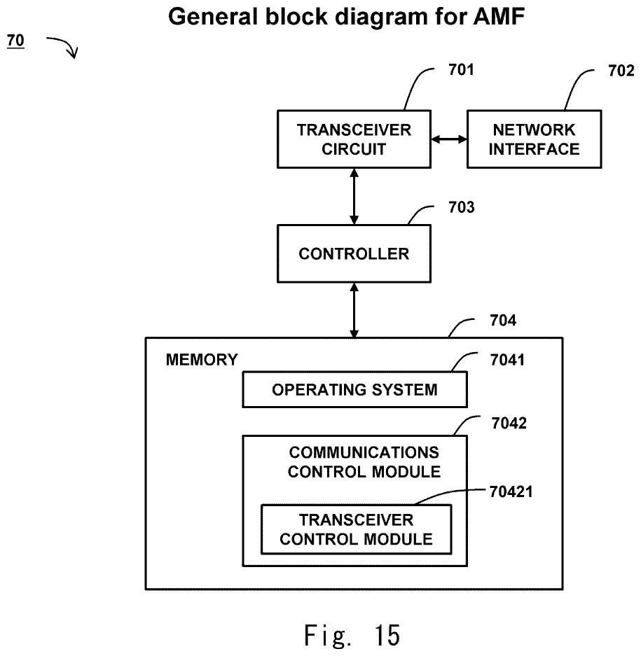

FIG. 15 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (e.g., a removable memory device (RMD)), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g., via the (R)AN node 5) and other core network nodes (including core network nodes in the HPLMN of the UE 3 when the UE 3 is roaming-in. Such signalling may include, for example, appropriately formatted signalling messages (e.g., a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### (SMF)

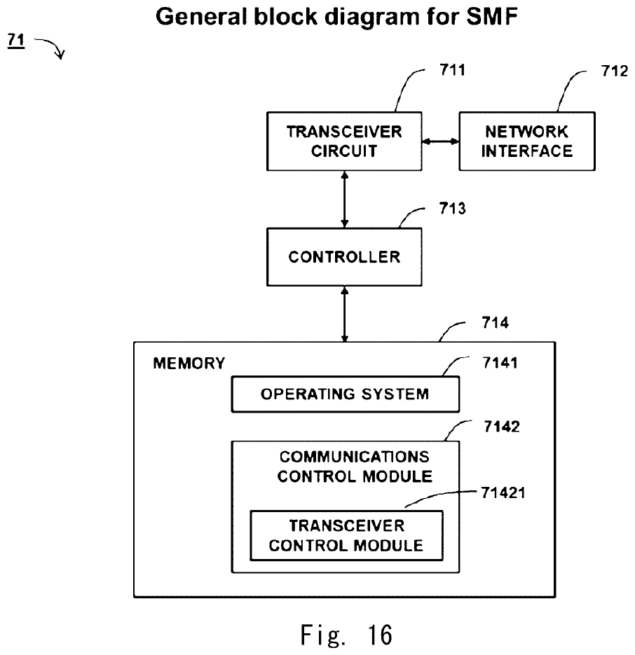

FIG. 16 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g., a Hypertext Transfer Protocol (HTTP) restful methods based on the service-based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### (UPF)

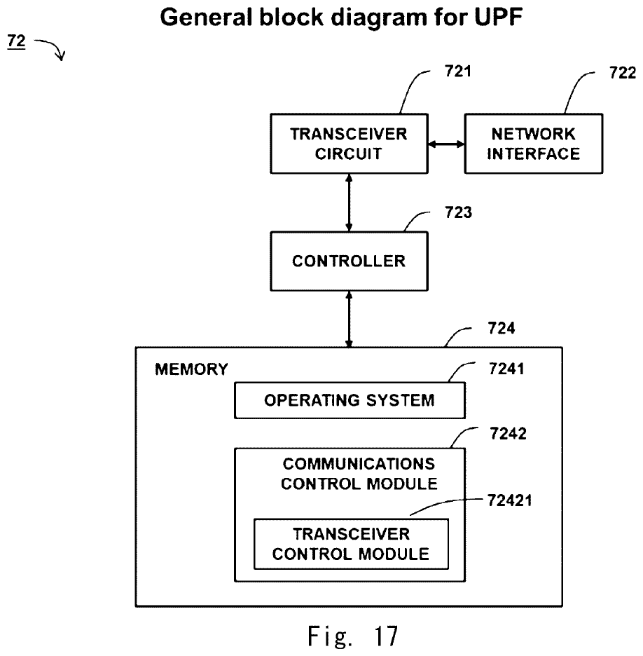

FIG. 17 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g., a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g., a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### (PCF)

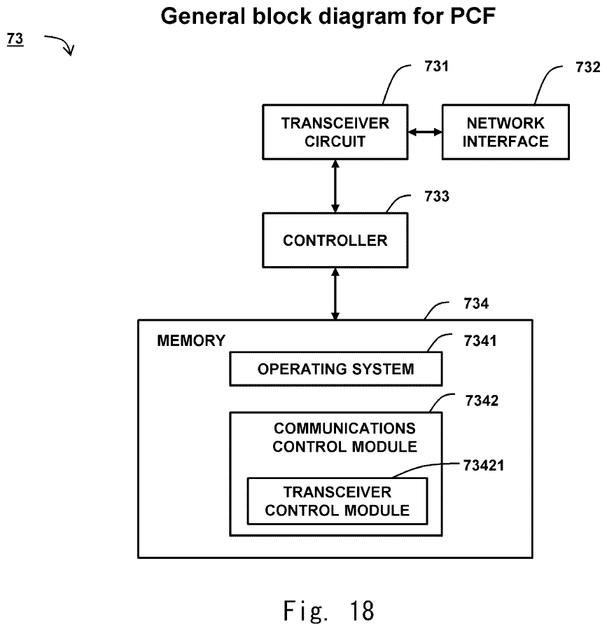

FIG. 18 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g., a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g., a HTTP restful methods based on the service-based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### (NEF)

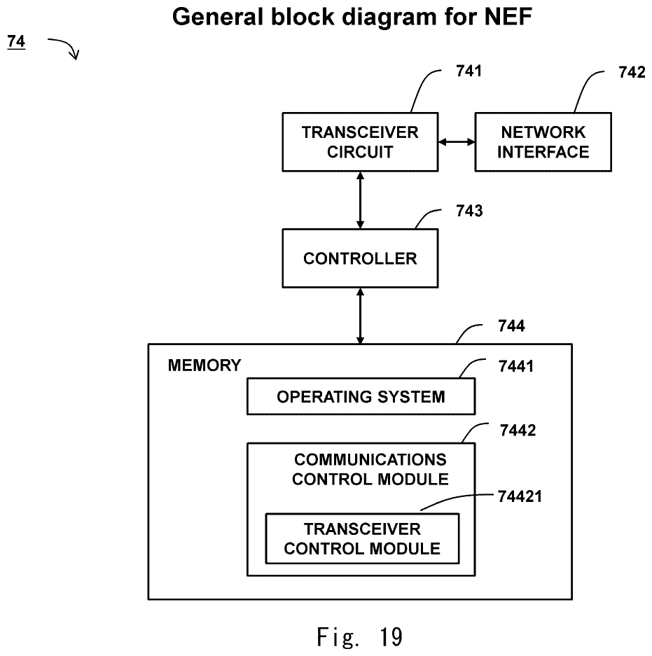

FIG. 19 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g., a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the NEF 74 and other nodes, such as the UDM 75 and other core network nodes (including core network nodes in the HPLMN of the UE 3 when the UE 3 is roaming-in. Such signalling may include, for example, appropriately formatted signalling messages (e.g., a HTTP restful methods based on the service-based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### (UDM)

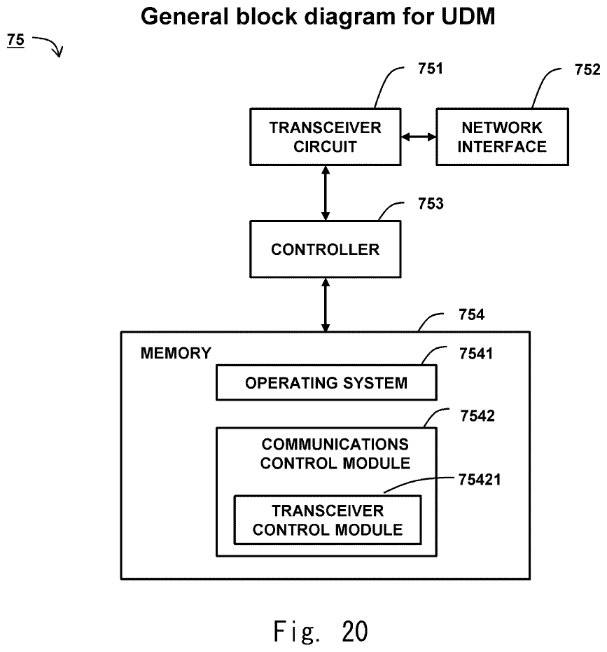

FIG. 20 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (e.g., a removable memory device (RMD)), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g., a HTTP restful methods based on the service-based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### (NSSF)

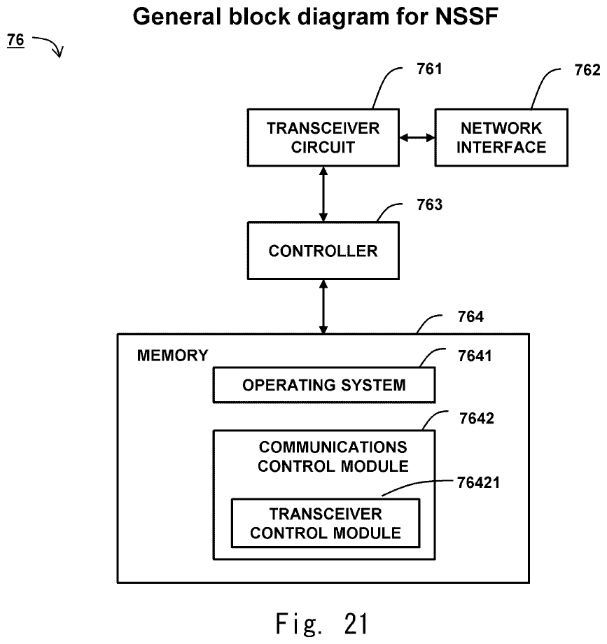

FIG. 21 is a block diagram illustrating the main components of the NSSF 76. As shown, the apparatus includes a transceiver circuit 761 which is operable to transmit signals to and to receive signals from other nodes (including the AMF 70) via a network interface 762. A controller 763 controls the operation of the NSSF 76 in accordance with the software stored in a memory 764. The Software may be pre-installed in the memory 764 and/or may be downloaded via the telecommunication network or from a removable data storage device (e.g., a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSF 76 and other nodes, such as the AMF 70 and other core network nodes (including core network nodes in the HPLMN of the UE 3 when the UE 3 is roaming-in. Such signalling may include, for example, appropriately formatted signalling messages (e.g., a HTTP restful methods based on the service-based interfaces) relating to network data analytics function procedures (for the UE 3).

The NSSF 76 may support the Non-Public Network (NPN), The NPN may be a Stand-alone Non-Public Network (SNPN) or a Public Network Integrated NPN (PNI-NPN).

### (NSACF)

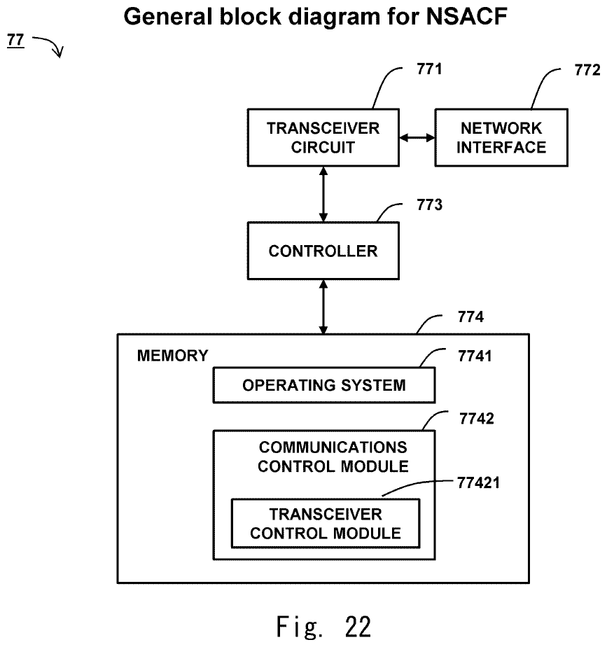

FIG. 22 is a block diagram illustrating the main components of the NSACF 77. As shown, the apparatus includes a transceiver circuit 771 which is operable to transmit signals to and to receive signals from other nodes (including the AMF 70 and the SMF 71) via a network interface 772. A controller 773 controls the operation of the NSACF 77 in accordance with the software stored in a memory 774. The Software may be pre-installed in the memory 774 and/or may be downloaded via the telecommunication network or from a removable data storage device (e.g., a removable memory device (RMD)), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NSACF 77 and other nodes, such as the AMF 70 and other core network nodes (including core network nodes in the HPLMN of the UE 3 when the UE 3 is roaming-in. Such signalling may include, for example, appropriately formatted signalling messages (e.g., a HTTP restful methods based on the service-based interfaces) relating to network data analytics function procedures (for the UE 3).

The NSACF 77 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); Input/Output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g., WLAN, Wi-Fi, WiMAX, Bluetooth, etc.) and other fix line communications technology (e.g., BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description, but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.

### Supplementary Note 1

A method of a communication apparatus, the method comprising:
receiving a first message including Single Network Slice Selection Assistance Information (S-NSSAI);
determining whether the S-NSSAI has an attribute related to a maximum number of User Equipments (UEs) that use a network slice simultaneously with at least one of a Protocol Data Unit (PDU) session and a Packet Data Network (PDN) connection; and
retaining sending a second message in a case of determining that the S-NSSAI has the attribute,
wherein the second message includes the S-NSSAI for performing a number of UEs per network slice availability check and update procedure.

### Supplementary Note 2

The method according to supplementary note 1, further comprising:
sending the second message in a case of determining that the S-NSSAI does not have the attribute.

### Supplementary Note 3

The method according to supplementary note 1 or 2, further comprising:
sending a third message in a case of determining that the S-NSSAI has the attribute,
wherein the third message includes a list including at least one S-NSSAI that the number of UEs per network slice availability check and update procedure is not performed, and
wherein the S-NSSAI is included in the list.

### Supplementary Note 4

The method according to supplementary note 3,
wherein the third message is a registration accept message.

### Supplementary Note 5

The method according to any one of supplementary notes 1 to 4,
wherein the first message is a registration request message, and
wherein the second message is an Nnsacf_NSAC_NumOfUEsUpdate_Request message.

### Supplementary Note 6

The method according to any one of supplementary notes 1 to 5, further comprising:
receiving a fourth message including the S-NSSAI;
sending a fifth message including the S-NSSAI;
receiving a sixth message including information,
wherein the information indicates that a maximum number of registered UEs for the S-NSSAI is reached; and
sending a seventh message including Rejected NSSAI which includes the S-NSSAI.

### Supplementary Note 7

The method according to supplementary note 6,
wherein the fourth message is a PDU session establishment request message, and
wherein the seventh message is a PDU session establishment reject message.

### Supplementary Note 8

A method of a communication apparatus, the method comprising:
receiving a first message including Single Network Slice Selection Assistance Information (S-NSSAI);
determining whether the S-NSSAI has an attribute related to a maximum number of User Equipments (UEs) that use a network slice simultaneously with at least one of a Protocol Data Unit (PDU) session and a Packet Data Network (PDN) connection; and
sending a second message in a case of determining that the S-NSSAI has the attribute,
wherein the second message includes the S-NSSAI for performing a number of UEs per network slice availability check and update procedure.

### Supplementary Note 9

The method according to supplementary note 8,
wherein the first message is a PDU session establishment request message, and
wherein the second message is an Nnsacf_NSAC_NumOfUEsUpdate_Request message.

### Supplementary Note 10

The method according to supplementary note 8 or 9,
wherein the S-NSSAI in the first message is included in a list, and
wherein the list including at least one S-NSSAI that the number of UEs per network slice availability check and update procedure is not performed.

### Supplementary Note 11

The method according to any one of supplementary notes 8 to 10, further comprising:
receiving a third message including information,
wherein the information indicates that a maximum number of registered UEs for the S-NSSAI is reached; and
sending a fourth message including the information.

### Supplementary Note 12

The method according to supplementary note 11,
wherein the third message is an Nnsacf_NSAC_NumOfUEsUpdate_Response message.

### Supplementary Note 13

A method of a User Equipment (UE), the method comprising,
sending a first message including Single Network Slice Selection Assistance Information (S-NSSAI); and
receiving a second message including a list which includes at least one S-NSSAI that a number of UEs per network slice availability check and update procedure is not performed in a case where the S-NSSAI has an attribute related to a maximum number of UEs that use a network slice simultaneously with at least one of a Protocol Data Unit (PDU) session and a Packet Data Network (PDN) connection, and
wherein the S-NSSAI is included in the list.

### Supplementary Note 14

The method according to supplementary note 13,
wherein the first message is a registration request message, and
wherein the second message is a registration accept message.

### Supplementary Note 15

The method according to supplementary note 13 or 14, further comprising: sending a third message including the list,
wherein the third message is a PDU session establishment request message; and
receiving a fourth message in a case where a maximum number of registered UEs for the S-NSSAI is reached,
wherein the fourth message is a PDU session establishment reject message, and
wherein the fourth message includes Rejected NSSAI which includes the S-NSSAI.

### Supplementary Note 16

A method of a communication apparatus, the method comprising:
receiving a first message including Single Network Slice Selection Assistance Information (S-NSSAI) from an Access and Mobility Management Function (AMF);
determining whether the S-NSSAI has an attribute related to a maximum number of User Equipments (UEs) that use a network slice simultaneously with at least one of a Protocol Data Unit (PDU) session and a Packet Data Network (PDN) connection; and
retaining performing a number of UEs per network slice availability check and update procedure for the S-NSSAI in a case of determining that the S-NSSAI has the attribute.

### Supplementary Note 17

The method according to supplementary note 16, further comprising:
sending a second message,
wherein the second message includes a list including at least one S-NSSAI that the number of UEs per network slice availability check and update procedure is not performed,
wherein the S-NSSAI is included in the list, and
wherein the second message is an Nnsacf_NSAC_NumOfUEsUpdate_Response message.

### Supplementary Note 18

The method according to supplementary note 17, further comprising:
receiving a third message including the list from Session Management Function (SMF);
determining whether the S-NSSAI in the list has the attribute; and
performing the number of UEs per network slice availability check and update procedure for the S-NSSAI in a case of determining that the S-NSSAI has the attribute.

### Supplementary Note 19

The method according to supplementary note 16 or 17, further comprising:
receiving a third message including the S-NSSAI from Session Management Function (SMF);
determining whether the S-NSSAI has the attribute; and
performing the number of UEs per network slice availability check and update procedure for the S-NSSAI in a case of determining that the S-NSSAI has the attribute.

### Supplementary Note 20

The method according to any one of supplementary notes 16 to 19,
wherein the first message is an Nnsacf_NSAC_NumOfUEsUpdate_Request message.

### Supplementary Note 21

A method of a communication apparatus, the method comprising:
communicating with another communication apparatus; and
sending, to the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

### Supplementary Note 22

A method of a communication apparatus, the method comprising:
communicating with another communication apparatus; and
receiving, from the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

### Supplementary Note 23

A communication apparatus comprising:
means for receiving a first message including Single Network Slice Selection Assistance Information (S-NSSAI);
means for determining whether the S-NSSAI has an attribute related to a maximum number of User Equipments (UEs) that use a network slice simultaneously with at least one of a Protocol Data Unit (PDU) session and a Packet Data Network (PDN) connection; and
means for retaining sending a second message in a case of determining that the S-NSSAI has the attribute,
wherein the second message includes the S-NSSAI for performing a number of UEs per network slice availability check and update procedure.

### Supplementary Note 24

The communication apparatus according to supplementary note 23, further comprising:
means for sending the second message in a case of determining that the S-NSSAI does not have the attribute.

### Supplementary Note 25

The communication apparatus according to supplementary note 23 or 24, further comprising:
means for sending a third message in a case of determining that the S-NSSAI has the attribute,
wherein the third message includes a list including at least one S-NSSAI that the number of UEs per network slice availability check and update procedure is not performed, and
wherein the S-NSSAI is included in the list.

### Supplementary Note 26

The communication apparatus according to supplementary note 25,
wherein the third message is a registration accept message.

### Supplementary Note 27

The communication apparatus according to any one of supplementary notes 23 to 26,
wherein the first message is a registration request message, and
wherein the second message is an Nnsacf_NSAC_NumOfUEsUpdate_Request message.

### Supplementary Note 28

The communication apparatus according to any one of supplementary notes 23 to 27, further comprising:
means for receiving a fourth message including the S-NSSAI;
means for sending a fifth message including the S-NSSAI;
means for receiving a sixth message including information,
wherein the information indicates that a maximum number of registered UEs for the S-NSSAI is reached; and
means for sending a seventh message including Rejected NSSAI which includes the S-NSSAI.

### Supplementary Note 29

The communication apparatus according to supplementary note 28,
wherein the fourth message is a PDU session establishment request message, and
wherein the seventh message is a PDU session establishment reject message.

### Supplementary Note 30

A communication apparatus comprising:
means for receiving a first message including Single Network Slice Selection Assistance Information (S-NSSAI);
means for determining whether the S-NSSAI has an attribute related to a maximum number of User Equipments (UEs) that use a network slice simultaneously with at least one of a Protocol Data Unit (PDU) session and a Packet Data Network (PDN) connection; and
means for sending a second message in a case of determining that the S-NSSAI has the attribute,
wherein the second message includes the S-NSSAI for performing a number of UEs per network slice availability check and update procedure.

### Supplementary Note 31

The communication apparatus according to supplementary note 30,
wherein the first message is a PDU session establishment request message, and
wherein the second message is an Nnsacf_NSAC_NumOfUEsUpdate_Request message.

### Supplementary Note 32

The communication apparatus according to supplementary note 30 or 31,
wherein the S-NSSAI in the first message is included in a list, and
wherein the list including at least one S-NSSAI that the number of UEs per network slice availability check and update procedure is not performed.

### Supplementary Note 33

The communication apparatus according to any one of supplementary notes 30 to 32, further comprising:
means for receiving a third message including information,
wherein the information indicates that a maximum number of registered UEs for the S-NSSAI is reached; and
means for sending a fourth message including the information.

### Supplementary Note 34

The communication apparatus according to supplementary note 33,
wherein the third message is an Nnsacf_NSAC_NumOfUEsUpdate_Response message.

### Supplementary Note 35

A User Equipment (UE) comprising,
means for sending a first message including Single Network Slice Selection Assistance Information (S-NSSAI); and
means for receiving a second message including a list which includes at least one S-NSSAI that a number of UEs per network slice availability check and update procedure is not performed in a case where the S-NSSAI has an attribute related to a maximum number of UEs that use a network slice simultaneously with at least one of a Protocol Data Unit (PDU) session and a Packet Data Network (PDN) connection, and
wherein the S-NSSAI is included in the list.

### Supplementary Note 36

The UE according to supplementary note 35,
wherein the first message is a registration request message, and
wherein the second message is a registration accept message.

### Supplementary Note 37

The UE according to supplementary note 35 or 36, further comprising:
means for sending a third message including the list,
wherein the third message is a PDU session establishment request message; and
means for receiving a fourth message in a case where a maximum number of registered UEs for the S-NSSAI is reached,
wherein the fourth message is a PDU session establishment reject message, and
wherein the fourth message includes Rejected NSSAI which includes the S-NSSAI.

### Supplementary Note 38

A communication apparatus comprising:
means for receiving a first message including Single Network Slice Selection Assistance Information (S-NSSAI) from an Access and Mobility Management Function (AMF);
means for determining whether the S-NSSAI has an attribute related to a maximum number of User Equipments (UEs) that use a network slice simultaneously with at least one of a Protocol Data Unit (PDU) session and a Packet Data Network (PDN) connection; and
means for retaining performing a number of UEs per network slice availability check and update procedure for the S-NSSAI in a case of determining that the S-NSSAI has the attribute.

### Supplementary Note 39

The communication apparatus according to supplementary note 38, further comprising:
means for sending a second message,
wherein the second message includes a list including at least one S-NSSAI that the number of UEs per network slice availability check and update procedure is not performed,
wherein the S-NSSAI is included in the list, and
wherein the second message is an Nnsacf_NSAC_NumOfUEsUpdate_Response message.

### Supplementary Note 40

The communication apparatus according to supplementary note 39, further comprising:
means for receiving a third message including the list from Session Management Function (SMF);
means for determining whether the S-NSSAI in the list has the attribute; and
means for performing the number of UEs per network slice availability check and update procedure for the S-NSSAI in a case of determining that the S-NSSAI has the attribute.

### Supplementary Note 41

The communication apparatus according to supplementary note 38 or 39, further comprising:
means for receiving a third message including the S-NSSAI from Session Management Function (SMF);
means for determining whether the S-NSSAI has the attribute; and
means for performing the number of UEs per network slice availability check and update procedure for the S-NSSAI in a case of determining that the S-NSSAI has the attribute.

### Supplementary Note 42

The communication apparatus according to any one of supplementary notes 38 to 41,
wherein the first message is an Nnsacf_NSAC_NumOfUEsUpdate_Request message.

### Supplementary Note 43

A communication apparatus comprising:
means for communicating with another communication apparatus; and
means for sending, to the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

### Supplementary Note 44

A communication apparatus comprising:
means for communicating with another communication apparatus; and
means for receiving, from the another communication apparatus, information indicating that Single Network Slice Selection Assistance Information (S-NSSAI) has an attribute related to a maximum number of User Equipments that use a network slice simultaneously with at least one of a Protocol Data Unit (PDU) session and a Packet Data Network (PDN) connection.

### Supplementary Note 45

A method performed by a first communication apparatus, the method comprising:
receiving a first message from a second communication apparatus for Network Slice Admission Control (NSAC) for maximum number of User Equipments (UEs) with at least one Protocol Data Unit (PDU) session/Packet Data Network (PDN) connection based on a UE establishing a PDU session/PDN connection associated with a network slice in the second communication apparatus; and
performing NSAC for maximum number of UEs with at least one PDU session/PDN connection.

### Supplementary Note 46

The method according to supplementary note 45, the method further comprising:
keeping track of a current number of UEs with at least one PDU session/PDN connection established on a network slice to ensure the current number of UEs does not exceed a maximum number of UEs.

### Supplementary Note 47

The method according to supplementary note 46, the method further comprising:
sending a second message to the second communication apparatus based on the current number of UEs with at least one PDU session/PDN connection has already been reached to the maximum number of UEs.

### Supplementary Note 48

The method according to any one of supplementary notes 45-47, wherein the first message is Nnsacf_NSAC_NumOFUEsUpdate_Request message.

### Supplementary Note 49

The method according to any one of supplementary notes 45-48, wherein the second message is response message.

### Supplementary Note 50

The method according to any one of supplementary notes 45-49, wherein the first communication apparatus is Network Slice Admission Control Function (NSACF).

### Supplementary Note 51

The method according to any one of supplementary notes 45-50, wherein the second communication apparatus is Session Management Function (SMF).

### Supplementary Note 52

A method performed by a second communication apparatus, the method comprising:
sending a first message to a first communication apparatus for Network Slice Admission Control (NSAC) for maximum number of User Equipments (UEs) with at least one Protocol Data Unit (PDU) session/Packet Data Network (PDN) connection based on a UE establishing a PDU session/PDN connection associated with a network slice in the second communication apparatus; and
receiving a second message from the first communication apparatus based on the first message being received by the first communication apparatus and a current number of UEs with at least one PDU session/PDN connection has already been reached to a maximum number of UEs.

### Supplementary Note 53

The method according to supplementary note 52, the method further comprising:
sending cause related to a number of UEs in the network slice based on the maximum number of UEs with at least one PDU Session/PDN connection has already been reached and the receiving the second message from the first communication apparatus.

### Supplementary Note 54

The method according to supplementary note 52 or 53, wherein the first message is Nnsacf_NSAC_NumOFUEsUpdate_Request message.

### Supplementary Note 55

The method according to any one of supplementary notes 52-54, wherein the second message is response message.

### Supplementary Note 56

The method according to any one of supplementary notes 52-55, wherein the first communication apparatus is Network Slice Admission Control Function (NSACF).

### Supplementary Note 57

The method according to any one of supplementary notes 52-56, wherein the second communication apparatus is Session Management Function (SMF).

This application is based upon and claims the benefit of priority from Indian Patent Application number 202311006516, filed on Feb. 1, 2023, the disclosure of which is incorporated herein in its entirety by reference.

### REFERENCE SIGNS LIST

20 DATA NETWORK
201 CSCF
3 UE
31 TRANSCEIVER CIRCUIT
32 ANTENNA
33 CONTROLLER
34 USER INTERFACE
35 USIM
36 MEMORY
361 OPERATING SYSTEM
362 COMMUNICATIONS CONTROL MODULE
3621 TRANSCEIVER CONTROL MODULE
5 (R)AN NODE
51 TRANSCEIVER CIRCUIT
52 ANTENNA
53 NETWORK INTERFACE
54 CONTROLLER
55 MEMORY
551 OPERATING SYSTEM
552 COMMUNICATIONS CONTROL MODULE
5521 TRANSCEIVER CONTROL MODULE
60 RU
601 TRANSCEIVER CIRCUIT
602 ANTENNA
603 NETWORK INTERFACE
604 CONTROLLER
605 MEMORY
6051 OPERATING SYSTEM
6052 COMMUNICATIONS CONTROL MODULE
60521 TRANSCEIVER CONTROL MODULE
61 DU
611 TRANSCEIVER CIRCUIT
612 NETWORK INTERFACE
613 CONTROLLER
614 MEMORY
6141 OPERATING SYSTEM
6142 COMMUNICATIONS CONTROL MODULE
61421 TRANSCEIVER CONTROL MODULE
62 CU
621 TRANSCEIVER CIRCUIT
622 NETWORK INTERFACE
623 CONTROLLER
624 MEMORY
6241 OPERATING SYSTEM
6242 COMMUNICATIONS CONTROL MODULE
62421 TRANSCEIVER CONTROL MODULE
7 CORE NETWORK
70 AMF
701 TRANSCEIVER CIRCUIT
702 NETWORK INTERFACE
703 CONTROLLER
704 MEMORY
7041 OPERATING SYSTEM
7042 COMMUNICATIONS CONTROL MODULE
70421 TRANSCEIVER CONTROL MODULE
71 SMF
711 TRANSCEIVER CIRCUIT
712 NETWORK INTERFACE
713 CONTROLLER
714 MEMORY
7141 OPERATING SYSTEM
7142 COMMUNICATIONS CONTROL MODULE
71421 TRANSCEIVER CONTROL MODULE
72 UPF
721 TRANSCEIVER CIRCUIT
722 NETWORK INTERFACE
723 CONTROLLER
724 MEMORY
7241 OPERATING SYSTEM
7242 COMMUNICATIONS CONTROL MODULE
72421 TRANSCEIVER CONTROL MODULE
73 PCF
731 TRANSCEIVER CIRCUIT
732 NETWORK INTERFACE
733 CONTROLLER
734 MEMORY
7341 OPERATING SYSTEM
7342 COMMUNICATIONS CONTROL MODULE
73421 TRANSCEIVER CONTROL MODULE
74 NEF
741 TRANSCEIVER CIRCUIT
742 NETWORK INTERFACE
743 CONTROLLER
744 MEMORY
7441 OPERATING SYSTEM
7442 COMMUNICATIONS CONTROL MODULE
74421 TRANSCEIVER CONTROL MODULE
75 UDM
751 TRANSCEIVER CIRCUIT
752 NETWORK INTERFACE
753 CONTROLLER
754 MEMORY
7541 OPERATING SYSTEM
7542 COMMUNICATIONS CONTROL MODULE
75421 TRANSCEIVER CONTROL MODULE
76 NSSF
761 TRANSCEIVER CIRCUIT
762 NETWORK INTERFACE
763 CONTROLLER
764 MEMORY
7641 OPERATING SYSTEM
7642 COMMUNICATIONS CONTROL MODULE
76421 TRANSCEIVER CONTROL MODULE
77 NSACF
771 TRANSCEIVER CIRCUIT
772 NETWORK INTERFACE
773 CONTROLLER
774 MEMORY
7741 OPERATING SYSTEM
7742 COMMUNICATIONS CONTROL MODULE
77421 TRANSCEIVER CONTROL MODULE

What is claimed is:

1.-57. (canceled)

58. A method performed by a first communication apparatus, the method comprising:
receiving a first message from a second communication apparatus for Network Slice Admission Control (NSAC) for a maximum number of User Equipments (UEs) with at least one Protocol Data Unit (PDU) session/Packet Data Network (PDN) connection based on a UE establishing a PDU session/PDN connection associated with a network slice in the second communication apparatus; and
performing NSAC for the maximum number of UEs with at least one PDU session/PDN connection in case of EPC interworking.

59. The method according to claim 58, the method further comprising:
keeping track of a current number of UEs with at least one PDU session/PDN connection established on the network slice to ensure the current number of UEs does not exceed the maximum number of UEs.

60. The method according to claim 59, the method further comprising:
sending a second message to the second communication apparatus based on the current number of UEs with at least one PDU session/PDN connection has already been reached to the maximum number of UEs.

61. The method according to claim 60, wherein the first message is a Nnsacf_NSAC_NumOFUEsUpdate_Request message.

62. The method according to claim 61, wherein the second message is a response message.

63. The method according to claim 62, wherein the first communication apparatus is a Network Slice Admission Control Function (NSACF).

64. The method according to claim 63, wherein the second communication apparatus is a Session Management Function (SMF).

65. A method performed by a second communication apparatus, the method comprising:
sending a first message to a first communication apparatus for Network Slice Admission Control (NSAC) for a maximum number of User Equipments (UEs) with at least one Protocol Data Unit (PDU) session/Packet Data Network (PDN) connection based on a UE establishing a PDU session/PDN connection associated with a network slice in the second communication apparatus; and
receiving a second message from the first communication apparatus based on the first message being received by the first communication apparatus and a current number of UEs with at least one PDU session/PDN connection has already been reached to the maximum number of UEs.

66. The method according to claim 65, the method further comprising:
sending cause related to a number of UEs in the network slice based on the maximum number of UEs with at least one PDU Session/PDN connection has already been reached and the receiving the second message from the first communication apparatus.

67. The method according to claim 66, wherein the first message is a Nnsacf_NSAC_NumOFUEsUpdate_Request message.

68. The method according to claim 67, wherein the second message is a response message.

69. The method according to claim 68, wherein the first communication apparatus is a Network Slice Admission Control Function (NSACF).

70. The method according to claim 69, wherein the second communication apparatus is a Session Management Function (SMF).

71. A method performed by User Equipment (UE), the method comprising:
sending, to a second communication apparatus, a Protocol Data Unit (PDU) session Establishment Request message including first information of a network slice,
wherein the second communication apparatus sends a first message to a first communication apparatus for Network Slice Admission Control (NSAC) for a maximum number of UEs with at least one PDU session/Packet Data Network (PDN) connection based on a UE establishing a PDU session/PDN connection associated with the network slice in the second communication apparatus; and
receiving, from the second communication apparatus, a PDU session Establishment Reject message including second information,
wherein the second information includes a rejection of the network slice based on a second message, the second message being sent from the first communication apparatus to the second communication apparatus based on the first message being received by the first communication apparatus and a current number of UEs with at least one PDU session/PDN connection has already been reached to the maximum number of UEs.
